(19) United States
(12) Patent Application Publication
(10) Pub. No.: US 2026/0040158 A1
(43) Pub. Date: Feb. 5, 2026

(54) METHOD AND DEVICE FOR SLICE-BASED CELL RESELECTION USING PAGING MESSAGE IN WIRELESS COMMUNICATION SYSTEM

(71) Applicant: SAMSUNG ELECTRONICS CO., LTD., Suwon-si, Gyeonggi-do (KR)

(72) Inventors: Sangyeob JUNG, Suwon-si (KR); Anil AGIWAL, Suwon-si (KR); Hyunjeong KANG, Suwon-si (KR)

(21) Appl. No.: 18/996,509

(22) PCT Filed: Jul. 20, 2023
(86) PCT No.: PCT/KR2023/010518

§ 371 Date: Jan. 17, 2025

(30) Foreign Application Priority Data
Jul. 22, 2022 (KR) 10-2022-0091324

(51) Int. Cl. H04W 36/00; H04W 36/08; H04W 36/24

(52) U.S. Cl. CPC H04W 36/0061; H04W 36/08; H04W 36/249

(57) ABSTRACT

The disclosure relates to a 5^{th} generation (5G) or 6^{th} generation (6G) communication system for supporting a higher data transmission rate. The disclosure relates to a method and device by which a user equipment (UE) performs cell reselection based on slice information. A UE according to an embodiment of the disclosure may receive a paging message including slice information from a base station. The UE may perform cell reselection based on the slice information and may perform a random access procedure based on a result of the cell reselection.

### TECHNICAL FIELD

The disclosure relates to a method and device for cell reselection based on slice information transmitted and received by using a paging message in a wireless communication system.

### BACKGROUND ART

5^{th} generation (5G) mobile communication technologies define broad frequency bands so that high transmission rates and new services are possible, and may be implemented not only in “Sub 6 GHZ” bands such as 3.5 GHz, but also in “Above 6 GHz” bands referred to as mmWave including 28 GHz and 39 GHz. In addition, it has been considered to implement 6^{th} generation (6G) mobile communication technologies (referred to as Beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input multiple output (MIMO) for mitigating radio-wave path loss and increasing radio-wave transmission distances in mmWave, supporting numerologies (e.g., operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is UE-satellite direct communication for providing coverage in an area in which communication with terrestrial networks is unavailable, and positioning.

Moreover, there has been ongoing standardization n in air interface architecture/protocol regarding technologies such as industrial internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR). There also has been ongoing standardization in system architecture/service regarding a 5G baseline architecture (e.g., service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and artificial intelligence (AI) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE

### Technical Problem

The disclosure provides a method and device for reselecting a cell based on slice information transmitted and received by using a paging message in a wireless communication system.

### Technical Solution

A method performed by a user equipment (UE) in a wireless communication system according to an embodiment of the disclosure may include receiving a paging message including slice information from a base station. The method may include performing cell reselection based on the slice information. The method may include performing a random access procedure based on a result of the cell reselection.

A method performed by a base station in a wireless communication system according to an embodiment of the disclosure may include transmitting a paging message including slice information to a user equipment (UE). The method may include performing a random access procedure based on a result of cell reselection based on the slice information.

A user equipment (UE) for performing communication in a wireless communication system according to an embodiment of the disclosure may include a transceiver and at least one processor connected to the transceiver. The processor may be configured to receive a paging message including slice information from a base station. The processor may be configured to perform cell reselection based on the slice information, and perform a random access procedure based on a result of the cell reselection.

A base station for performing communication in a wireless communication system according to an embodiment of the disclosure may include a transceiver and at least one processor connected to the transceiver. The processor may be configured to transmit a paging message including slice information to a user equipment (UE). The processor may be configured to perform a random access procedure based on a result of cell reselection based on the slice information.

### DESCRIPTION OF DRAWINGS

FIG. 1A is a diagram illustrating a structure of a long-term evolution (LTE) system, according to an embodiment of the disclosure.

FIG. 1B is a diagram illustrating a radio protocol architecture of an LTE system, according to an embodiment of the disclosure.

FIG. 1C is a diagram illustrating a structure of a wireless communication system, according to an embodiment of the disclosure.

FIG. 1D is a diagram illustrating a radio protocol architecture of a wireless communication system, according to an embodiment of the disclosure.

FIG. 1E is a diagram for describing a process in which a user equipment (UE) is configured with a slice group and a slice group priority through an access and mobility management function (AMF) in a wireless communication system.

FIG. 1F is a diagram illustrating a process in which a UE supporting slice-based cell reselection performs a slice-based cell reselection procedure in a wireless communication system, according to an embodiment of the disclosure.

FIG. 1G is a diagram illustrating a process in which a UE supporting slice-based cell reselection receives a paging message including slice information from a base station (BS) in a wireless communication system, according to an embodiment of the disclosure.

FIG. 1H is a diagram illustrating a process in which a UE supporting slice-based cell reselection receives a paging message including slice information from a BS in a wireless communication system, according to an embodiment of the disclosure.

FIG. 1I is a diagram illustrating a process in which a UE receives a paging message including slice information from a BS in a wireless communication system, according to an embodiment of the disclosure.

FIG. 1J is a diagram illustrating a process in which a UE receives a paging message including slice information from a BS in a wireless communication system, according to an embodiment of the disclosure.

FIG. 1K is a diagram illustrating a process in which a UE receives a paging message including slice information from a BS in a wireless communication system, according to an embodiment of the disclosure.

FIG. 1L is a block diagram illustrating an internal structure of a UE, according to an embodiment of the disclosure.

FIG. 1M is a block diagram illustrating a configuration of a new radio (NR) base station, according to an embodiment of the disclosure.

### MODE FOR INVENTION

Hereinafter, operational principles of the disclosure will be described in detail with reference to the accompanying drawings. In the following descriptions of the disclosure, well-known functions or configurations are not described in detail because they would obscure the disclosure with unnecessary details. The terms used herein are those defined in consideration of functions in the disclosure, and may vary according to the intention of users or operators, precedents, etc. Hence, the terms used herein should be defined based on the meaning of the terms together with the descriptions throughout the specification.

In the following descriptions of the disclosure, well-known functions or configurations are not described in detail because they would obscure the disclosure with unnecessary details. Hereinafter, embodiments of the disclosure will be described with reference to the drawings.

Hereinafter, terms for identifying access nodes, terms indicating network entities, terms indicating messages, terms indicating interfaces between network entities, and terms indicating various identification information used herein are exemplified for convenience of explanation. Accordingly, the disclosure is not limited to the terms described below, and other terms indicating objects having equal technical meanings may be used.

Hereinafter, some terms and names defined in the 3^{rd} generation partnership project long term evolution (3GPP LTE) standard are used for convenience of explanation. However, the disclosure may not be limited to the terms and names and may also be applied to systems following other standards. In the disclosure, an evolved node B (eNB) may be interchangeably used with a next-generation node B (gNB) for convenience of explanation. That is, a base station (BS) described as an eNB may represent a gNB.

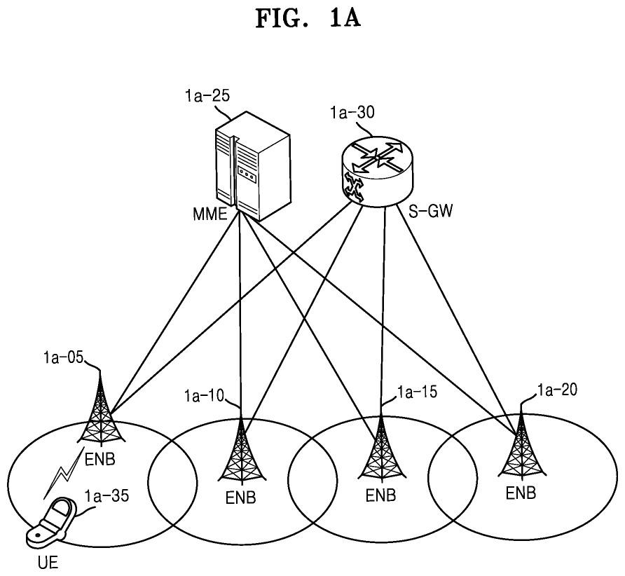

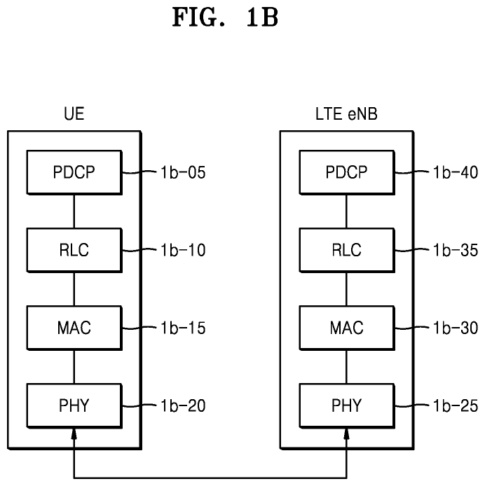

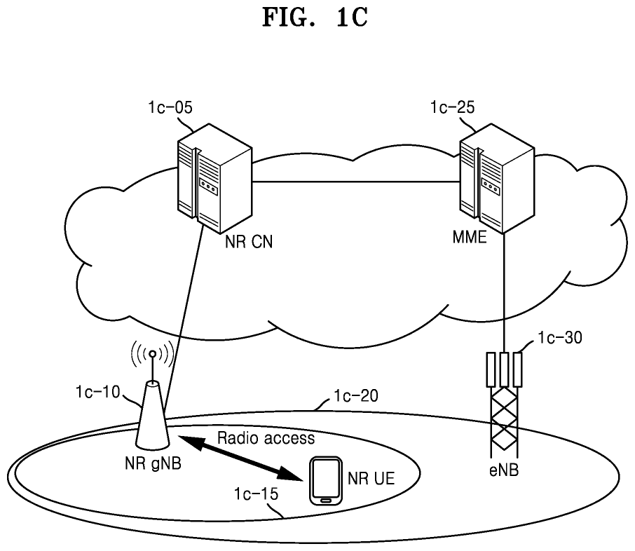

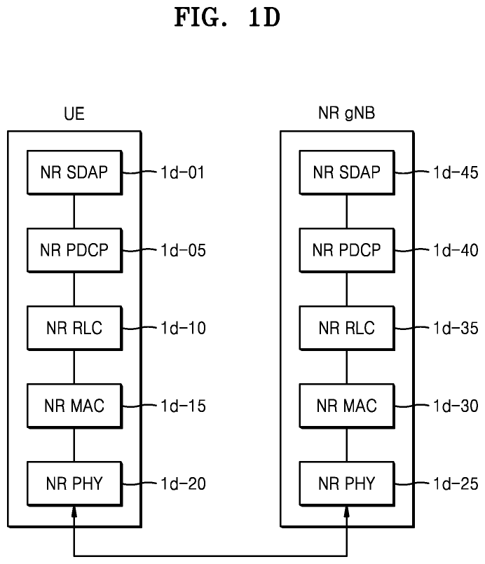

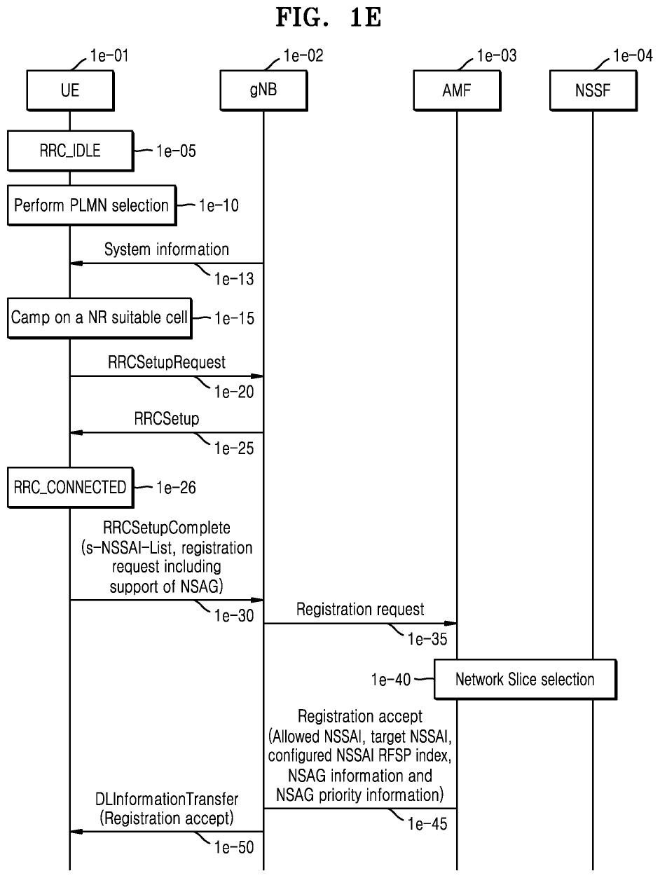

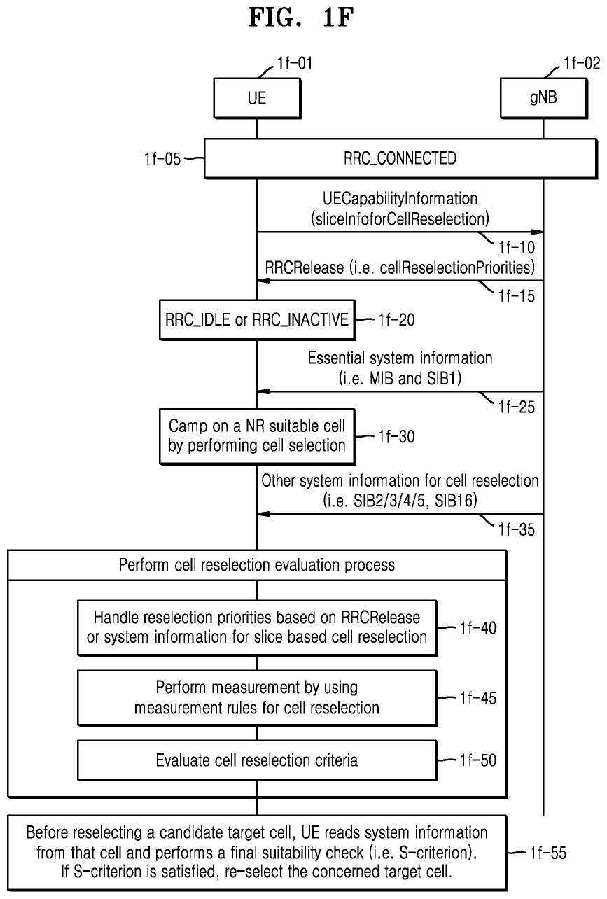

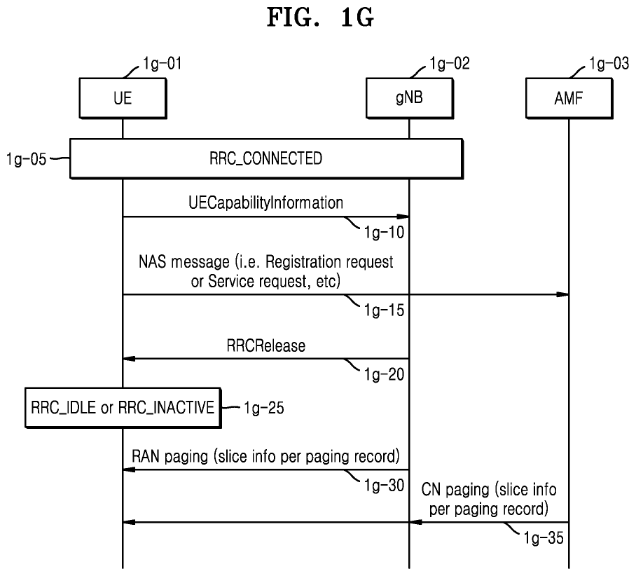

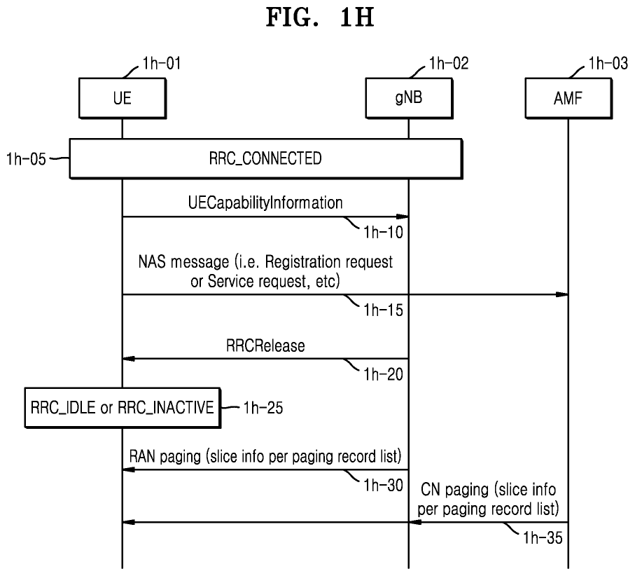

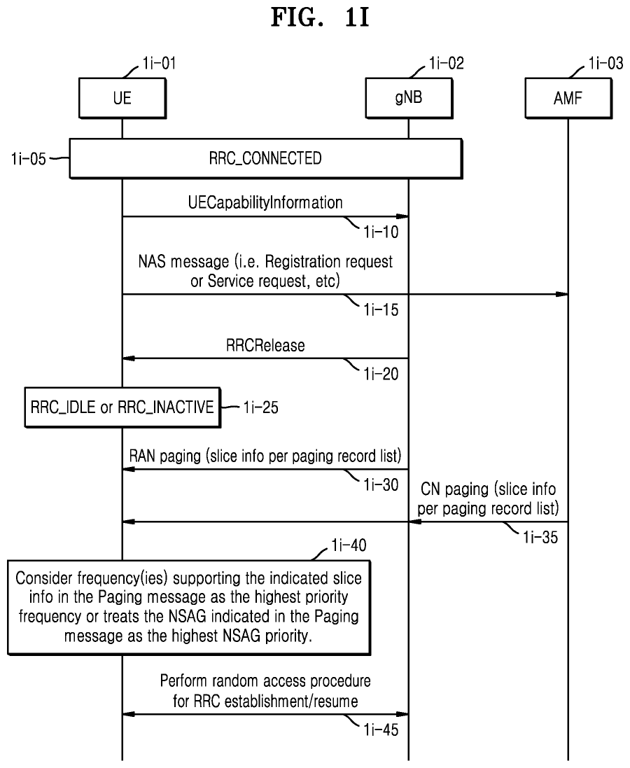

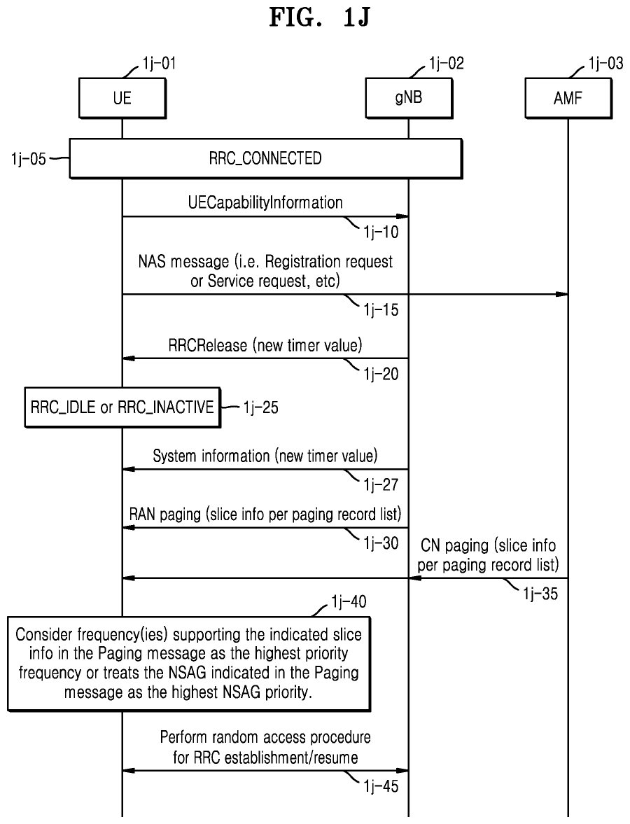

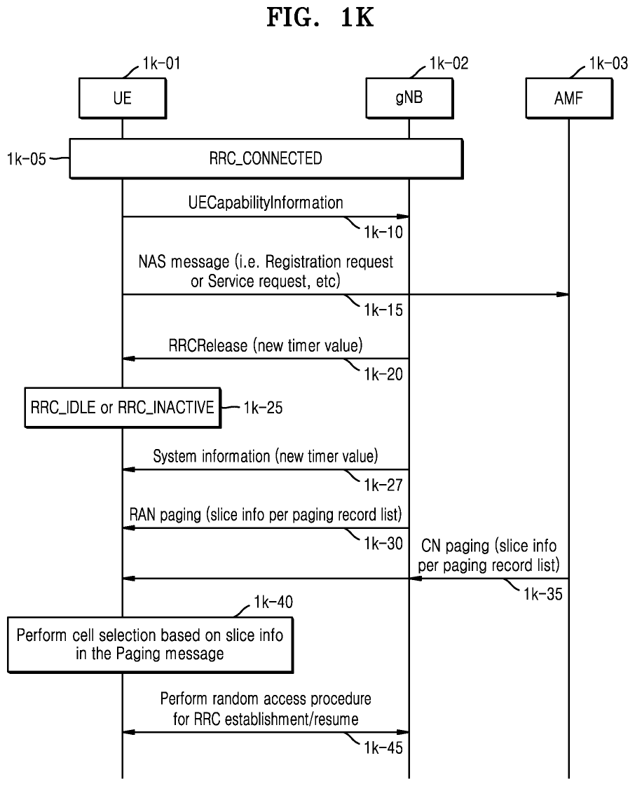

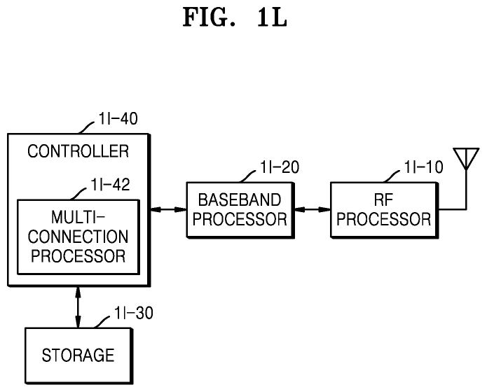

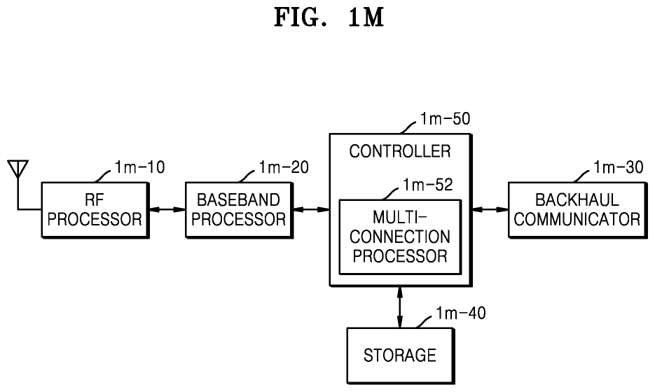

FIG. 1A is a diagram illustrating a structure of a long-term evolution (LTE) system, according to an embodiment of the disclosure.

Referring to FIG. 1A, a radio access network of the LTE system may include next-generation BSs (e.g., evolved node Bs (ENBs), node Bs, or BSs) 1a-05, 1a-10, 1a-15, and 1a-20, a mobility management entity (MME) 1a-25, and a serving-gateway (S-GW) 1a-30. A user equipment (UE) (or a terminal) 1a-35 may access an external network through the ENBs 1a-05 to 1a-20 and the S-GW 1a-30.

In FIG. 1A, each of the ENBs 1a-05 to 1a-20 may correspond to an existing node B of a universal mobile telecommunications system (UMTS). The ENB may be connected to the UE 1a-35 through a wireless channel and may perform a more complicated function than the existing node B. All user traffic data including real-time services such as voice over Internet protocol (VoIP) may be serviced through shared channels in the LTE system, and thus an entity for performing scheduling by collecting state information, e.g., buffer state information, available transmission power state information, and channel state information, of UEs may be required and the ENB 1a-05, 1a-10, 1a-15, or 1a-20 may operate as such an entity. One ENB may generally control a plurality of cells. For example, in order to implement a transmission rate of 100 Mbps, the LTE system may use, for example, orthogonal frequency division multiplexing (OFDM) in a bandwidth of 20 MHz as a radio access technology. Also, adaptive modulation & coding (AMC) may be applied to determine a modulation scheme and a channel coding rate in accordance with a channel state of a UE. The S-GW 1a-30 is an entity for providing a data bearer, and may add or remove a data bearer under the control of the MME 1a-25. The MME is an entity for performing various control functions as well as a mobility management function for the UE, and may be connected to a plurality of BSs.

FIG. 1B is a diagram illustrating a radio protocol architecture of an LTE system, according to an embodiment of the disclosure.

Referring to FIG. 1B, a radio protocol architecture of an LTE system includes packet data convergence protocols (PDCPs) 1b-05 and 1b-40, radio link controls (RLCs) 1b-10 and 1b-35, and medium access controls (MACs) 1b-15 and 1b-30 of respectively at a UE and an ENB. The PDCPs 1b-05 and 1b-40 perform operations such as internet protocol (IP) header compression/reconstruction. The main functions of the PDCP may be summarized as follows.
Header compression and decompression: robust reader compression (ROHC) only
Transfer of user data
In-sequence delivery of upper layer packet data units (PDUs) at PDCP re-establishment procedure for RLC acknowledged mode (AM)
For split bearers in dual connectivity (DC) (only support for RLC AM): PDCP PDU routing for transmission and PDCP PDU reordering for reception
Duplicate detection of lower layer service data units (SDUs) at PDCP re-establishment procedure for RLC AM
Retransmission of PDCP SDUs at handover and, for split bearers in DC, of PDCP PDUs at PDCP data-recovery procedure, for RLC AM
Ciphering and deciphering
Timer-based SDU discard in uplink

The RLCs 1b-10 and 1b-35 may perform an automatic repeat request (ARQ) operation by reconfiguring a PDCP packet data unit (PDU) to an appropriate size. Main functions of the RLCs 1b-10 and 1b-35 may be summarized as follows.
Transfer of upper layer PDUs
Error correction through ARQ (only for AM data transfer)
Concatenation, segmentation and reassembly of RLC SDUs (only for unacknowledged mode (UM) and AM data transfer)
Re-segmentation of RLC data PDUs (only for AM data transfer)
Reordering of RLC data PDUs (only for UM and AM data transfer)
Duplicate detection (only for UM and AM data transfer)
Protocol error detection (only for AM data transfer)
RLC SDU discard (only for UM and AM data transfer)
RLC re-establishment

The MACs 1b-15 and 1b-30 may be connected to a plurality of RLC layers configured in one UE, may multiplex RLC PDUs into a MAC PDU, and may demultiplex the RLC PDUs from the MAC PDU. Main functions of the MACs 1b-15 and 1b-30 may be summarized as follows.
Mapping between logical channels and transport channels
Multiplexing/demultiplexing of MAC SDUs belonging to one or different logical channels into/from transport blocks (TBs) delivered to/from the physical layer on transport channels
Scheduling information reporting
Error correction through HARQ
Priority handling between logical channels of one UE
Priority handling between UEs by means of dynamic scheduling
Multimedia broadcast multicast service (MBMS) identification
Transport format selection
Padding

Physical layers 1b-20 and 1b-25 perform an operation of channel-coding and modulating upper layer data, making the channel-coded and modulated upper layer data into OFDM symbols, and transmitting the OFDM symbols through a wireless channel, or demodulating OFDM symbols received through a wireless channel, channel-decoding the demodulated OFDM symbols, and transmitting the decoded OFDM symbols to an upper layer.

FIG. 1C is a diagram illustrating a structure of a wireless communication system, according to an embodiment of the disclosure.

Referring to FIG. 1C, a radio access network of the wireless communication system (hereinafter, a new radio (NR) or 2G system) may include a next-generation BS (a new radio node B, e.g., NR gNB or NR BS) 1c-10 and a new radio core network (NR CN) 1c-05. An NR UE (or a NR terminal) 1c-15 may access an external network 1c-20 through the NR gNB 1c-10 and the NR CN 1c-05.

In FIG. 1C, the NR gNB 1c-10 corresponds to an evolved node B (eNB) of an existing LTE system. The NR gNB is connected to the NR UE 1c-15 through a wireless channel and may provide a superior service compared to an existing B. All user traffic data may be serviced through shared channels in the wireless communication system, and thus, an entity for performing scheduling by collecting state information, e.g., buffer state information, available transmission power state information, and channel state information of UEs may be required and the NR gNB 1c-10 may operate as such an entity. One NR gNB may generally control a plurality of cells. In order to implement ultra-high speed data transmission in comparison with current LTE, an existing maximum bandwidth or more may be provided and beamforming may be additionally applied by using OFDM as a radio access technology. Also, AMC may be applied to determine a modulation scheme and a channel coding rate in accordance with a channel state of a UE. The NR CN 1c-05 may perform functions such as mobility support, bearer configuration, and quality of service (QoS) configuration. The NR CN is an entity for performing various control functions as well as a mobility management function for the UE, and may be connected to a plurality of BSs. Also, the wireless communication system may interoperate with the existing LTE system, and the NR CN may be connected to an MME 1c-25 via a network interface. The MME may be connected to an eNB 1c-30 that is an existing BS.

FIG. 1D is a diagram illustrating a radio protocol architecture of a wireless communication system, according to an embodiment of the disclosure.

Referring to FIG. 1D, a radio protocol of a wireless communication system may include NR service data adaptation protocols (SDAP) 1d-01 and 1d-45, NR PDCPs 1d-05 and 1d-40, NR RLCs 1d-10 and 1d-35, and NR MACs 1d-15 and 1d-30 respectively at a UE and an NR BS.

Main functions of the NR SDAPs 1d-01 and 1d-45 may include at least some of the following functions.
Transfer of user plane data
Mapping between a QoS flow and a data radio bearer (DRB) for both downlink (DL) and uplink (UL)
Marking QoS flow ID in both DL and UL packets
Reflective QoS flow to DRB mapping for the UL SDAP PDUs

With regard to an SDAP layer, the UE may be configured with information about whether to use a header of the SDAP layer or to use functions of the SDAP layer, through an RRC message per PDCP layer, per bearer, or per logical channel. When the SDAP header is configured, a 1-bit non-access stratum (NAS) reflective QoS configuration indicator and a 1-bit access stratum (AS) reflective QoS configuration indicator of the SDAP header may be used to indicate the UE to update or reconfigure mapping information between a QoS flow and a data bearer for both UL and DL. The SDAP header may include QoS flow ID information indicating the QoS. The QoS information may be used as a data-processing priority, scheduling information, or the like in order to support a smooth service.

Main functions of the NR PDCPs 1d-05 and 1d-40 may include at least some of the following functions.
Header compression and decompression: ROHC only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink

The reordering function of the NR PDCPs 1d-05 and 1d-40 refers to a function of reordering PDCP PDUs received from a lower layer in order based on a PDCP sequence number (SN), and may include a function of delivering data to an upper layer in the reordering order or a function of immediately delivering the data to the upper layer without considering an order, a function of recording missing PDCP PDUs by reordering the PDCP PDUs, a function of reporting a state of the missing PDCP PDUs to a transmitter, and a function of requesting retransmission of the missing PDCP PDUs.

Main functions of the NR RLCs 1d-10 and 1d-35 may include at least some of the following functions.
Transfer of upper layer PDUs
In-sequence delivery of upper layer PDUs
Out-of-sequence delivery of upper layer PDUs
Error correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

The in-sequence delivery function of the NR RLC layer refers to a function of delivering RLC SDUs received from a lower layer to an upper layer in order. The in-sequence delivery function of the NR RLC layer may include a function of reassembling the RLC SDUs and delivering the reassembled RLC SDU when a plurality of RLC SDUs segmented from one RLC SDU are received, a function of reordering received RLC PDUs on an RLC SN or PDCP SN basis, a function of recording missing RLC PDUs by reordering the received RLC PDUs, a function of reporting state information of the missing RLC PDUs to a transmitter, a function of requesting to retransmit the missing RLC PDUs, a function of delivering only RLC SDUs prior to a missing RLC SDU, to an upper layer in order when the missing RLC SDU exists, or a function of delivering all RLC SDUs received before a timer starts, to an upper layer in order although a missing RLC SDU exists when a certain timer expires. The NR RLC may process the RLC PDUs in order of reception regardless of an order of sequence numbers (out-of-sequence delivery) and deliver the same to the NR PDCP 1d-05 or 1d-40. When segments are received, the NR RLC may receive segments to be received later or stored in a buffer, reassemble the segments into a whole RLC PDU, process the whole RLC PDU, and deliver the same to the PDCP. The NR RLC may not include a concatenation function, and the concatenation function may be performed in an NR MAC, or may be replaced with a multiplexing function of the NR MAC.

The out-of-sequence delivery function of the NR RLC refers to a function of immediately delivering RLC SDUs received from a lower layer, to an upper layer out of an order, and may include a function of reassembling and delivering RLC SDUs, when a single RLC SDU is segmented into a plurality of RLC SDUs and received, and a function of storing RLC SNs or PDCP SNs of received RLC PDUs and recording missing RLC PDUs by aligning the received RLC PDUs in order.

The NR MACs 1d-15 and 1d-30 may be connected to a plurality of NR RLC layers configured in one UE, and main functions of the NR MACs may include at least some of the following functions.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
Multimedia broadcast multicast service (MBMS) identification
Transport format selection
Padding

NR PHY layers 1d-20 and 1d-25 may channel-code and modulate upper layer data into OFDM symbols and transmit the OFDM symbols through a wireless channel, or may demodulate OFDM symbols received through a wireless channel and channel-decode and deliver the OFDM symbols to an upper layer.

FIG. 1E is a diagram for describing a process in which a UE is configured with a slice group and a slice group priority through an access and mobility management function (AMF) in a wireless communication system.

The slice group of the disclosure may include one or more slices. The slice group may be referred to as a network slice AS group (NSAG). The UE supporting the NSAG may be configured with NSAG information and a priority value for each NSAG by a NAS message through the AMF. The NSAG information may be configured for each tracking area (TA). The NSAG information may include at least one of an NSAG identifier (NSAG-Id) for identifying each NSAG, mapping information about which NSAG a specific slice belongs to, and a tracking area identity (TAI) for each NSAG. For refence, when the same NSAG identifier is used for each TA but an NSAG includes different slice(s), NSAG information may include a TAI. That is, when a specific NSAG does not include a TAI, this may indicate that mapping of same slice(s) is applied in all TAs belonging to a registration area (RA) of the UE.

Referring to FIG. 1E, a UE 1e-01 may be in an RRC idle mode (RRC_IDLE) (1e-05).

In 1e-10, the UE 1e-01 in the RRC idle mode may perform a public land mobile network (PLMN) selection process.

In operation 1e-15, the UE 1e-01 in the RRC idle mode may camp on an NR suitable cell through a cell selection or cell reselection process by receiving (1e-13) system information broadcast from an NR BS 1e-02.

The UE 1e-01 in the RRC idle mode may perform an RRC connection setup procedure with the cell on which the UE 1e-01 camps. In detail, in operation 1e-20, the UE 1e-01 may transmit an RRC connection setup request message (RRCSetupRequest) to the NR BS 1e-02. In operation 1e-25, the NR BS 1e-02 may transmit an RRC connection setup message to the UE 1e-01. When receiving the RRC connection setup message, the UE 1e-01 may apply setup information included in the RRC connection setup message, and thus, may transition to an RRC-connected mode (RRC_CONNECTED) (1e-26).

In operation 1e-30, the UE 1e-01 that has transitioned to the RRC-connected mode may transmit an RRC connection setup complete message to the NR BS 1e-02. If an upper layer entity provides one or more pieces of single network slice selection assistance information (S-NSSAI), the UE 1e-01 may include, in the RRC connection setup complete message, an S-NSSAI-List including values provided by the upper layer entity, and may transmit the RRC connection setup complete message to the NR BS 1e-02. The S-NSSAI-List may include one or more pieces of S-NSSAI, each S-NSSAI may be configured of slice/service type (SST) or SST and slice/service type and slice differentiator (SST-SD), and a structure of Abstract Syntax Notation One (ASN.1) is as follows.

### S-NSSAI

The IE S-NSSAI (Single Network Slice Selection Assistance Information) identifies a Network Slice end to end and comprises a slice/service type and a slice differentiator, see TS 23.003 [21].

### S-NSSAI Information Element

| -- ASN1START | |
|---|---|
| -- TAG-S-NSSAI-START | |
| S-NSSAI ::= | CHOICE{ |
| sst | BIT STRING (SIZE (8)), |
| sst-SD | BIT STRING (SIZE (32)) |

}
-- TAG-S-NSSAI-STOP
-- ASN1STOP

S-NSSAI field descriptions

sst
Indicates the S-NSSAI consisting of Slice/Service Type, see TS 23.003
[21].
sst-SD
Indicates the S-NSSAI consisting of Slice/Service Type and Slice
Differentiator, see TS 23.003 [21].

In operation 1e-30, the UE 1e-01 may include, in the RRC connection setup complete message, a NAS message (DedicatedNAS-Message), and may transmit the RRC connection setup complete message to the NR BS 1e-02. For example, the NAS message may indicate a registration request message. The NAS message may include whether an NSAG is supported.

In operation 1e-35, the NR BS 1e-02 may forward the registration request message to an AMF 1e-03.

In operation 1e-40, a network slicing selection function (NSSF) 1e-04 may select a network slice supportable in a 5G core, and may forward information about the selected network slice to the AMF 1e-03.

In operation 1e-45, the AMF 1e-03 may transmit, to the NR BS 1e-02, a registration accept message including at least one of NSAG information about one or more pieces of NSSAI and NSAG priority information. The NSAG information may include at least one of items below.
Mapping information about which NSAG one or more slices belong to, and an identifier for each NSAG (NSAG-Id)
Up to 32 NSAGs may be configured for each PLMN, and NSAG(s) may be unique for each PLMN.
Information for each TA may be configured.
TAI or TA

For reference, the NSAG information and the NSAG priority information may be provided via a UE configuration command message. In operation 1e-45, the registration accept message may include information about target NSSAI that is not supported from among pieces of NSSAI requested by the UE 1e-01 and may be transmitted to the NR BS 1e-02. The registration accept message may also include a slice selection priority index value for each frequency/radio access technology (RAT) (Index to RAT/Frequency Slice Selection Priority (RFSP index)).

In operation 1e-50, the NR BS 1e-02 may transmit a DLInformation Transfer message to the UE 1e-01. The DLInformationTransfer message may include the registration accept message.

FIG. 1F is a diagram illustrating a process in which a UE supporting slice-based cell reselection performs a slice-based cell reselection procedure in a wireless communication system, according to an embodiment of the disclosure.

The UE of the disclosure may support slice-based cell reselection in a camped normally state (when camping on a suitable cell). That is, the UE may perform a slice-based cell reselection procedure by considering one or more NSAGs and a priority for each NSAG received from NAS.

Referring to FIG. 1F, a UE 1f-01 may be in an RRC connected mode (RRC_CONNECTED) by setting up RRC connection with an NR BS 1f-02 (1f-05). For reference, the UE 1f-01 may be configured with NSAG information and NSAG priority information by a NAS message via an AMF, as in the embodiment described above.

In operation 1f-10, the UE 1f-01 may transmit a UE capability information message (UECapabilityInformation) to the NR BS 1f-02. The UE capability information message may include the following indicator (sliceInfoforCellReselection).
Indicator whether the UE supports slice reselection information in system information block (SIB) and on RRCRelease for slice based cell reselection in RRC_IDLE and RRC_INACTIVE.

In operation 1f-15, the NR BS 1f-02 may transmit an RRC connection release message (RRCRelease) to the UE 1f-01. The RRC connection release message may include cell reselection priority configuration information. The cell reselection priority configuration information may include at least one of items below.
Frequency priority list for EUTRA (freqPriorityListEUTRA)
FreqPriorityListEUTRA may include one or more FreqPriorityEUTRA, and may be a list including up to maxFreq(=8) FreqPriorityEUTRA. Each FreqPriorityEUTRA may be configured of at least one of a reference radio frequency channel number value (ARFCN-ValueEUTRA) indicating a carrier frequency, a cell reselection priority value (CellReselectionPriority), and a cell reselection sub-priority value (cellReselectionSubPriority). For reference, the cell reselection priority value may be configured as an integer value from among 0 to 7, and the cell reselection sub-priority value may be configured as a decimal value from among 0.2, 0.4, 0.6, and 0.8. If the cell reselection priority value and the cell reselection sub-priority value are simultaneously configured for a specific carrier frequency, the UE may add two values to derive a cell reselection priority value. If only one of the cell reselection priority value and the cell reselection sub-priority value is configured for a specific carrier frequency, the UE may derive a cell reselection priority value based on the configured value.
Frequency priority list for NR (freqPriorityListNR)
FreqPriorityListNR may include one or more FreqPriorityNR, and may be a list including up to maxFreq(=8) FreqPriorityNR (according to UE capability). FreqPriorityNR may be configured of at least one of a reference radio frequency channel number value (ARFCN-ValueNR) indicating a carrier frequency, a cell reselection priority value (CellReselectionPriority), and a cell reselection sub-priority value (cellReselectionSubPriority). As described above, the UE may derive a cell reselection priority value for each NR carrier frequency. In the disclosure, cell reselection priority information included in a list may be referred to as conventional cell reselection priority information.
t320 timer value
The timer value may be configured as a value from among 5 minutes (min), 10 min., 20 min., 30 min., 60 min., 120 min., and 180 min. The timer value may be configured as a value other than the examples above. The UE may run a T320 timer with the configured timer value, and may perform a cell reselection evaluation procedure by applying the cell reselection priority configuration information received via the RRC connection release message. That is, until the T320 timer expires or stops, the UE may perform the cell reselection evaluation procedure by applying the cell reselection priority configuration information received via the RRC connection release message. If the timer value is not configured, the UE may perform the cell reselection evaluation procedure by applying the cell reselection priority configuration information until the cell reselection priority configuration information received via the RRC connection release message is deleted. For reference, when the UE performs the cell reselection evaluation procedure by applying the cell reselection priority configuration information received via the RRC connection release message, the UE may ignore cell reselection priority configuration information broadcast via system information. For reference, the T320 timer and the above description may be commonly applied to the conventional cell reselection priority information and slice cell reselection priority information.
Slicing-dedicated frequency priority list (freqPriorityListDedicatedSlicing)
FreqPriorityListDedicatedSlicing may include one or more FreqPriorityDedicatedSlicing, and may be a list including up to maxFreq(=8) FreqPriorityDedicatedSlicing (according to UE capability). FreqPriorityDedicatedSlicing may be configured of at least one of a reference radio frequency channel number value (ARFCN-ValueNR) indicating a carrier frequency, and a slice-dedicated information list (SliceInfoListDedicated). SliceInfoListDedicated may be configured of at least one of NSAG identity information (NSAG-IdentityInfo), an NSAG cell reselection priority value (nsag-CellReselectionPriority), and an NSAG cell reselection sub-priority value (nsag-CellReselectionSubPriority). The NSAG cell reselection priority value may be configured as an integer value from the same range of the aforementioned cell reselection priority values, and the NSAG cell reselection sub-priority value may be configured as a decimal value from the same range of the aforementioned cell reselection sub-priority values. NSAG-IdentityInfo may be configured of at least one of NSAG identifier (NSAG-ID) and a tracking area code (trackingAreaCode). A cell reselection priority value for an NR carrier frequency included in each FreqPriorityDedicatedSlicing may be derived according to the aforementioned method. In the disclosure, for convenience of explanation, cell reselection priority information included in a list may be referred to as slice cell reselection priority information.

In operation 1f-15, the NR BS 1f-02 may transmit the RRC connection release message to the UE 1f-01 without simultaneously including the conventional cell reselection priority information and slice cell reselection priority information for the same NR frequency.

In operation 1f-20, the UE 1f-01 receiving RRCRelease may transition to an RRC idle mode or an RRC inactive mode. In detail, when RRCRelease including suspend configuration information (suspendConfig) is received, the UE may transition to an RRC inactive mode. Otherwise, the UE may transition to an RRC idle mode.

In operation 1f-25, the UE in the RRC idle mode or the RRC inactive mode may obtain essential system information. The essential system information may refer to master information block (MIB) and system information block 1 (SIB1)

In operation 1f-30, the UE in the RRC idle mode or the RRC inactive mode may camp on an NR suitable cell by performing a cell selection procedure. The cell on which the UE camps may be referred to as a serving cell.

In the disclosure, when a cell fulfills conditions of Table 1 below, based on the 3GPP standard specification of “38.304: User Equipment (UE) procedures in Idle mode and RRC Inactive state”, the cell may be defined as a suitable cell.

TABLE 1
suitable cell:

```
For UE not operating in SNPN Access Mode, a cell is considered as
  suitable if the following conditions are fulfilled:
-The cell is part of either the selected PLMN or the registered
  PLMN or PLMN of the Equivalent PLMN list, and for that PLMN
  either:
-The PLMN-ID of that PLMN is broadcast by the cell with no
  associated CAG-IDs and CAG-only indication in the UE for that
  PLMN (TS 23.501 [10]) is absent or false;
-Allowed CAG list in the UE for that PLMN (TS 23.501 [10])
  includes a CAG-ID broadcast by the cell for that PLMN;
-The cell selection criteria are fulfilled, see clause 5.2.3.2.
According to the latest information provided by NAS:
-The cell is not barred, see clause 5.3.1;
-The cell is part of at least one TA that is not part of the list of
  “Forbidden Tracking Areas for Roaming” (TS 22.011 [18]), which
  belongs to a PLMN that fulfils the first bullet above.
For UE operating in SNPN Access Mode, a cell is considered as
  suitable if the following conditions are fulfilled:
-The cell is part of either the selected SNPN or the registered
  SNPN of the UE;
-The cell selection criteria are fulfilled, see clause 5.2.3.2;
According to the latest information provided by NAS:
-The cell is not barred, see clause 5.3.1;
-The cell is part of at least one TA that is not part of the list of
  “Forbidden Tracking Areas for Roaming” which belongs to either
  the selected SNPN or the registered SNPN of the UE.
```

For reference, when Equation 1 is satisfied, the UE may determine that cell selection criteria are fulfilled.

$$Srxlev > 0 AND Squal > 0 \qquad [ Equation 1 ]$$

$$where$$

$$Srxlev = {Q}_{rxlevmes} - ( {Q}_{rxlevmin} + {Q}_{rxlevminoffset} ) - {P}_{compensation} - - {Qoffset}_{temp} ,$$

$$Squal = {Q}_{qualmeas} - ( {Q}_{qualmin} + {Q}_{qualminoffset} ) - {Qoffset}_{temp} .$$

Definitions of parameters used herein are based on the 3GPP standard specification “38.304: User Equipment (UE) procedures in Idle mode and RRC Inactive state”.

In operation 1f-35, in order to perform a cell reselection evaluation procedure, the UE 1f-01 in the RRC idle mode or the RRC inactive mode may obtain system information (e.g., SIB2, SIB3, SIB4, SIB5, or SIB16) including cell reselection information from the serving cell 1f-02. SIB2 may include information/parameter commonly applied for the UE to reselect an NR intra-frequency cell, an NR inter-frequency cell, and an inter-RAT frequency cell, and NR intra-frequency cell reselection information excluding information associated with an NR intra-frequency neighboring cell. For example, SIB2 may include cell reselection priority configuration information about a serving NR frequency (a frequency to which a currently-camped cell belongs). The cell reselection priority configuration information may indicate cellReselectionPriority and cellReselectionSubPriority. In detail, cellReselectionPriority may include an integer value (e.g., one integer value from among 0 to 7), and cellReselectionSubPriority may include a decimal value (e.g., one decimal value from among 0.2, 0.4, 0.6, and 0.8). If both cellReselectionPriority and cellReselectionSubPriority are signaled, the UE may derive a cell reselection priority value by adding two values. For reference, a larger cell reselection priority value indicates a higher priority. In detail, cell reselection configuration information broadcast by SIB2 may be as in Table 2 below.

TABLE 2

| | |
|---|---|
| SIB2 ::= | SEQUENCE { |
| cellReselectionInfoCommon | SEQUENCE { |
| nrofSS-BlocksToAverage | INTEGER |
| (2..maxNrofSS-BlocksToAverage) | OPTIONAL, -- |

Need S

| | |
|---|---|
| absThreshSS-BlocksConsolidation | ThresholdNR |

OPTIONAL, -- Need S

| | |
|---|---|
| rangeToBestCell | RangeToBestCell |

OPTIONAL, -- Need R

| | |
|---|---|
| q-Hyst | ENUMERATED { |
| | dB0, dB1, dB2, |

dB3, dB4, dB5, dB6, dB8, dB10,

dB12, dB14,

dB16, dB18, dB20, dB22, dB24},

| | |
|---|---|
| speedStateReselectionPars | SEQUENCE { |

mobilityStateParameters
MobilityStateParameters,

| | |
|---|---|
| q-HystSF | SEQUENCE { |
| sf-Medium | ENUMERATED |

{dB−6, dB−4, dB−2, dB0},

| | |
|---|---|
| sf-High | ENUMERATED |

```
{dB−6, dB−4, dB−2, dB0}
      }
    }
OPTIONAL, -- Need R
  ...
  },
```

| | |
|---|---|
| cellReselectionServingFreqInfo | SEQUENCE { |

s-NonIntraSearchP

| | |
|---|---|
| ReselectionThreshold | OPTIONAL, |

-- Need S
s-NonIntraSearchQ

| | |
|---|---|
| ReselectionThresholdQ | OPTIONAL, |

```
-- Need S
    threshServingLowP
ReselectionThreshold,
    threshServingLowQ
```

| | |
|---|---|
| ReselectionThresholdQ | OPTIONAL, |

-- Need R

| | |
|---|---|
| cellReselectionPriority | CellReselectionPriority, |

cellReselectionSubPriority

| | |
|---|---|
| CellReselectionSubPriority | OPTIONAL, |

```
-- Need R
    ...
  },
```

| | |
|---|---|
| intraFreqCellReselectionInfo | SEQUENCE { |
| q-RxLevMin | Q-RxLevMin, |
| q-RxLevMinSUL | Q-RxLevMin |

OPTIONAL, -- Need R

| | |
|---|---|
| q-QualMin | Q-QualMin |

```
OPTIONAL, -- Need S
    s-IntraSearchP
ReselectionThreshold,
    s-IntraSearchQ
```

| | |
|---|---|
| ReselectionThresholdQ | OPTIONAL, |

-- Need S

| | |
|---|---|
| t-ReselectionNR | T-Reselection, |

frequencyBandList

| | |
|---|---|
| MultiFrequencyBandListNR-SIB | OPTIONAL, |

-- Need S
frequencyBandListSUL

| | |
|---|---|
| MultiFrequencyBandListNR-SIB | OPTIONAL, |

-- Need R

| | |
|---|---|
| p-Max | P-Max |

OPTIONAL, -- Need S

| | |
|---|---|
| smtc | SSB-MTC |

OPTIONAL, -- Need S

| | |
|---|---|
| ss-RSSI-Measurement | SS-RSSI- |
| Measurement | OPTIONAL, -- |

Need R

| | |
|---|---|
| ssb-ToMeasure | SSB-ToMeasure |

OPTIONAL, -- Need S

| | |
|---|---|
| deriveSSB-IndexFromCell | BOOLEAN, |

```
    ...,
    [[
    t-ReselectionNR-SF
```

| | |
|---|---|
| SpeedStateScaleFactors | OPTIONAL |

```
-- Need N
    ]],
    [[
```

| | |
|---|---|
| smtc2-LP-r16 | SSB-MTC2-LP-r16 |

OPTIONAL, -- Need R

| | |
|---|---|
| ssb-PositionQCL-Common-r16 | SSB- |
| PositionQCL-Relation-r16 | OPTIONAL |

```
-- Cond SharedSpectrum
    ]]
  },
  ...,
  [[
```

| | |
|---|---|
| relaxedMeasurement-r16 | SEQUENCE { |
| lowMobilityEvaluation-r16 | SEQUENCE { |
| s-SearchDeltaP-r16 | ENUMERATED |

{

dB3, dB6,

dB9, dB12, dB15,

spare3,

spare2, spare1},

| | |
|---|---|
| t-SearchDeltaP-r16 | ENUMERATED { |
| | s5, s10, s20, |

s30, s60, s120, s180,

s240, s300,

spare7, spare6, spare5,

spare4,

spare3, spare2, spare1}
}
OPTIONAL, -- Need R

| | |
|---|---|
| cellEdgeEvaluation-r16 | SEQUENCE { |

```
      s-SearchThresholdP-r16
ReselectionThreshold,
      s-Search ThresholdQ-r16
```

| | |
|---|---|
| ReselectionThresholdQ | OPTIONAL |

-- Need R
}
OPTIONAL, -- Need R

| | |
|---|---|
| combineRelaxedMeasCondition-r16 | ENUMERATED |
| {true} | OPTIONAL, -- Need |

R

| | |
|---|---|
| highPriorityMeasRelax-r16 | ENUMERATED |
| {true} | OPTIONAL -- Need |

```
R
  }
OPTIONAL -- Need R
  ]]
}
RangeToBestCell ::= Q-OffsetRange
```

SIB3 may include neighboring cell information/parameter for the UE to reselect an NR intra-frequency cell. For example, SIB3 may broadcast an NR intra-frequency cell list (intraFreqNeighCellList) for reselecting an NR intra-frequency cell or a cell list (intraFreqBlackCellList) of cells for which NR intra-frequency cell reselection is not allowed. In detail, SIB3 may broadcast information as in Table 3 below.

TABLE 3

| SIB3 ::= | SEQUENCE { |
|---|---|
| intraFreqNeighCellList | IntraFreqNeighCellList |
| OPTIONAL, -- Need R | |
| intraFreqBlackCellList | IntraFreqBlackCellList |
| OPTIONAL, -- Need R | |
| lateNonCriticalExtension | OCTET STRING |
| OPTIONAL, | |
| ..., | |
| [[ | |
| intraFreqNeighCellList-v1610 | IntraFreqNeighCellList- |
| v1610 | OPTIONAL, -- Need |
| R | |
| intraFreqWhiteCellList-r16 | IntraFreqWhiteCellList- |
| r16 | OPTIONAL, -- Cond |
| SharedSpectrum2 | |
| intraFreqCAG-CellList-r16 | SEQUENCE (SIZE |
| (1..maxPLMN)) OF IntraFreqCAG-CellListPerPLMN-r16 | |
| OPTIONAL -- Need R | |
| ]] | |
| } | |
| IntraFreqNeighCellList ::= | SEQUENCE (SIZE |
| (1..maxCellIntra)) OF IntraFreqNeighCellInfo | |
| IntraFreqNeighCellList-v1610::= | SEQUENCE (SIZE |
| (1..maxCellIntra)) OF IntraFreqNeighCellInfo-v1610 | |
| IntraFreqNeighCellInfo ::= | SEQUENCE { |
| physCellId | PhysCellId, |
| q-OffsetCell | Q-OffsetRange, |
| q-RxLevMinOffsetCell | INTEGER (1..8) |
| OPTIONAL, -- Need R | |
| q-RxLevMinOffsetCellSUL | INTEGER (1..8) |
| OPTIONAL, -- Need R | |
| q-QualMinOffsetCell | INTEGER (1..8) |
| OPTIONAL, -- Need R | |
| ... | |
| } | |
| IntraFreqNeighCellInfo-v1610 ::= | SEQUENCE { |
| ssb-PositionQCL-r16 | SSB-PositionQCL- |
| Relation-r16 | OPTIONAL -- Cond |
| SharedSpectrum2 | |
| } | |
| IntraFreqBlackCellList ::= | SEQUENCE (SIZE |
| (1..maxCellBlack)) OF PCI-Range | |
| IntraFreqWhiteCellList-r16 ::= | SEQUENCE (SIZE |
| (1..maxCellWhite)) OF PCI-Range | |
| IntraFreqCAG-CellListPerPLMN-r16 ::= SEQUENCE { | |
| plmn-IdentityIndex-r16 | INTEGER |
| (1..maxPLMN), | |
| cag-CellList-r16 | SEQUENCE (SIZE |

(1..maxCAG-Cell-r16)) OF PCI-Range
}

SIB4 may include information/parameter for the UE to reselect an NR inter-frequency cell. For example, SIB4 may broadcast one or more NR inter-frequencies, and may broadcast cell reselection priority configuration information for each NR inter-frequency. The cell reselection priority configuration information for each NR inter-frequency indicates the contents above (e.g., cellReselectionPriority and/or cellReselectionSubPriority mapped to each NR inter-frequency), and cell reselection priority configuration information for each inter-frequency may be optionally broadcast. In detail, SIB4 may broadcast information as in Table 4 below.

TABLE 4

| | |
|---|---|
| SIB4 ::= | SEQUENCE { |
| interFreqCarrierFreqList | InterFreqCarrierFreqList, |
| lateNonCriticalExtension | OCTET STRING |

```
  OPTIONAL,
      ...,
      [[
      interFreqCarrierFreqList-v1610
```

| | |
|---|---|
| InterFreqCarrierFreqList-v1610 | OPTIONAL -- |

```
  Need R
      ]]
}
```

| | |
|---|---|
| InterFreqCarrierFreqList ::= | SEQUENCE (SIZE |

```
  (1..maxFreq)) OF InterFreqCarrierFreqInfo
InterFreqCarrierFreqList-v1610 ::= SEQUENCE (SIZE
  (1..maxFreq)) OF InterFreqCarrierFreqInfo-v1610
```

| | |
|---|---|
| InterFreqCarrierFreqInfo ::= | SEQUENCE { |
| dl-CarrierFreq | ARFCN-ValueNR, |

```
      frequencyBandList
  MultiFrequencyBandListNR-SIB
  OPTIONAL, -- Cond Mandatory
      frequencyBandListSUL
  MultiFrequencyBandListNR-SIB
  OPTIONAL, -- Need R
```

| | |
|---|---|
| nrofSS-BlocksToAverage | INTEGER |

```
  (2..maxNrofSS-BlocksToAverage)
  OPTIONAL, -- Need S
      absThreshSS-BlocksConsolidation ThresholdNR
  OPTIONAL, -- Need S
```

| | |
|---|---|
| smtc | SSB-MTC |

OPTIONAL, -- Need S

| | |
|---|---|
| ssbSubcarrierSpacing | SubcarrierSpacing, |
| ssb-ToMeasure | SSB-ToMeasure |

OPTIONAL, -- Need S

| | |
|---|---|
| deriveSSB-IndexFromCell | BOOLEAN, |
| ss-RSSI-Measurement | SS-RSSI-Measurement |

OPTIONAL,

| | |
|---|---|
| q-RxLevMin | Q-RxLevMin, |
| q-RxLevMinSUL | Q-RxLevMin |

OPTIONAL, -- Need R

| | |
|---|---|
| q-QualMin | Q-QualMin |

OPTIONAL, -- Need S

| | |
|---|---|
| p-Max | P-Max |

OPTIONAL, -- Need S

| | |
|---|---|
| t-ReselectionNR | T-Reselection, |
| t-ReselectionNR-SF | SpeedStateScaleFactors |

OPTIONAL, -- Need S

| | |
|---|---|
| threshX-HighP | ReselectionThreshold, |
| threshX-LowP | ReselectionThreshold, |
| threshX-Q | SEQUENCE { |

```
        threshX-HighQ
  ReselectionThreshoIdQ,
        threshX-LowQ
  ReselectionThreshoIdQ
      }
  OPTIONAL, -- Cond RSRQ
```

| | |
|---|---|
| cellReselectionPriority | CellReselectionPriority |

OPTIONAL, -- Need R

| | |
|---|---|
| cellReselectionSubPriority | CellReselectionSubPriority |

OPTIONAL, -- Need R

| | |
|---|---|
| q-OffsetFreq | Q-OffsetRange |

DEFAULT dB0,

| | |
|---|---|
| interFreqNeighCellList | InterFreqNeighCellList |

OPTIONAL, -- Need R

| | |
|---|---|
| interFreqBlackCellList | InterFreqBlackCellList |

```
  OPTIONAL; -- Need R
      ...
}
InterFreqCarrierFreqInfo-v1610 ::= SEQUENCE {
```

| | |
|---|---|
| interFreqNeighCellList-v1610 | InterFreqNeighCellList- |
| v1610 | OPTIONAL, -- Need R |
| smtc2-LP-r16 | SSB-MTC2-LP-r16 |

OPTIONAL, -- Need R

| | |
|---|---|
| interFreqWhiteCellList-r16 | InterFreqWhiteCellList- |
| r16 | OPTIONAL, -- Cond |

```
  SharedSpectrum2
      ssb-PositionQCL-Common-r16 SSB-PositionQCL-
```

| | |
|---|---|
| Relation-r16 | OPTIONAL, -- |

Cond SharedSpectrum

| | |
|---|---|
| interFreqCAG-CellList-r16 | SEQUENCE (SIZE |

```
  (1..maxPLMN)) OF InterFreqCAG-CellListPerPLMN-r16
  OPTIONAL -- Need R
}
```

| | |
|---|---|
| InterFreqNeighCellList ::= | SEQUENCE (SIZE |

(1..maxCellInter)) OF InterFreqNeighCellInfo

| | |
|---|---|
| InterFreqNeighCellList-v1610 ::= | SEQUENCE (SIZE |

(1..maxCellInter)) OF InterFreqNeighCellInfo-v1610

| | |
|---|---|
| InterFreqNeighCellInfo ::= | SEQUENCE { |
| physCellld | PhysCellId, |
| q-OffsetCell | Q-OffsetRange, |
| q-RxLevMinOffsetCell | INTEGER (1.8) |

OPTIONAL, -- Need R

| | |
|---|---|
| q-RxLevMinOffsetCellSUL | INTEGER (1..8) |

OPTIONAL, -- Need R

| | |
|---|---|
| q-QualMinOffsetCell | INTEGER (1..8) |

OPTIONAL, -- Need R
...
}

| | |
|---|---|
| InterFreqNeighCellInfo-v1610 ::= | SEQUENCE { |
| ssb-PositionQCL-r16 | SSB-PositionQCL- |
| Relation-r16 | OPTIONAL -- |

Cond SharedSpectrum2
}

| | |
|---|---|
| InterFreqBlackCellList ::= | SEQUENCE (SIZE |

(1..maxCellBlack)) OF PCI-Range

| | |
|---|---|
| InterFreqWhiteCellList-r16 ::= | SEQUENCE (SIZE |

(1..maxCellWhite)) OF PCI-Range
InterFreqCAG-CellListPerPLMN-r16 ::= SEQUENCE {

| | |
|---|---|
| plmn-IdentityIndex-r16 | INTEGER (1..maxPLMN), |
| cag-CellList-r16 | SEQUENCE (SIZE |

(1..maxCAG-Cell-r16)) OF PCI-Range
}

SIB5 may include information/parameter for the UE to reselect an inter-RAT frequency cell. For example, SIB5 may broadcast one or more EUTRA frequencies, and may broadcast cell reselection priority configuration information for each EUTRA frequency. The cell reselection priority configuration information for each EUTRA frequency indicates the contents above (e.g., cellReselectionPriority and/or cellReselectionSubPriority mapped to each EUTRA frequency), and cell reselection priority configuration information for each EUTRA frequency may be optionally broadcast. In detail, SIB5 may broadcast information as in Table 5 below.

TABLE 5

| SIB5 ::= | SEQUENCE { |
|---|---|
| carrierFreqListEUTRA | CarrierFreqListEUTRA |
| OPTIONAL -- Need R | |
| t-ReselectionEUTRA | T-Reselection, |
| t-ReselectionEUTRA-SF | |
| SpeedStateScaleFactors | OPTIONAL, - |
| - Need S | |
| lateNonCriticalExtension | OCTET STRING |
| OPTIONAL, | |
| ..., | |
| [[ | |
| carrierFreqListEUTRA-v1610 | CarrierFreqListEUTRA- |
| v1610 OPTIONAL -- Need R | |
| ]] | |
| } | |
| CarrierFreqListEUTRA ::- | SEQUENCE (SIZE |
| (1..maxEUTRA-Carrier)) OF CarrierFreqEUTRA | |
| CarrierFreqListEUTRA-v1610 ::= | SEQUENCE (SIZE |
| (1..maxEUTRA-Carrier)) OF CarrierFreqEUTRA-v1610 | |
| CarrierFreqEUTRA ::= | SEQUENCE { |
| carrierFreq | ARFCN-ValueEUTRA, |
| eutra-multiBandInfoList | EUTRA-MultiBandInfoList: |
| OPTIONAL -- Need R | |
| eutra-FreqNeighCellList | EUTRA- |
| FreqNeighCellList | OPTIONAL -- |
| Need R | |
| eutra-BlackCellList | EUTRA-FreqBlackCellList |
| OPTIONAL -- Need R | |
| allowedMeasBandwidth | EUTRA- |
| AllowedMeasBandwidth, | |
| presenceAntennaPort1 | EUTRA- |
| PresenceAntennaPort1, | |
| cellReselectionPriority | CellReselectionPriority |
| OPTIONAL -- Need R | |
| cellReselectionSubPriority | CellReselectionSubPriority |
| OPTIONAL -- Need R | |
| threshX-High | ReselectionThreshold, |
| threshX-Low | ReselectionThreshold, |
| q-RxLevMin | INTEGER (−70..−22), |
| q-QualMin | INTEGER (−34..−3), |
| p-MaxEUTRA | INTEGER (−30..33), |
| threshX-Q | SEQUENCE { |
| threshX-HighQ | |
| ReselectionThresholdQ, | |
| threshX-LowQ | |
| ReselectionThresholdQ | |
| } | |
| OPTIONAL -- Cond RSRQ | |
| } | |
| CarrierFreqEUTRA-v1610 ::= SEQUENCE { | |
| highSpeedEUTRACarrier-r16 | ENUMERATED {true} |
| OPTIONAL -- Need R | |
| } | |
| EUTRA-FreqBlackCellList ::= | SEQUENCE (SIZE |
| (1..maxEUTRA-CellBlack)) OF EUTRA-PhysCellldRange | |
| EUTRA-FreqNeighCellList ::= | SEQUENCE (SIZE |
| (1..maxCellEUTRA)) OF EUTRA-FreqNeighCellInfo | |
| EUTRA-FreqNeighCellInfo ::= | SEQUENCE { |
| physCellId | EUTRA-PhysCellId, |
| dummy | EUTRA-Q-OffsetRange, |
| q-RxLevMinOffsetCell | INTEGER (1..8) |
| OPTIONAL -- Need R | |
| q-QualMinOffsetCell | INTEGER (1..8) |

OPTIONAL -- Need R
}

SIB16 may include information/parameter for the UE to perform slice-based cell reselection. For example, SIB16 may broadcast slice-based cell reselection priority information for NR frequencies where the UE may perform slice-based cell reselection from among NR frequencies broadcast by SIB2 and SIB4. In detail, a slice information list (SliceInfoList) for each NR frequency where slice-based cell reselection may be performed may be broadcast. SliceInfoList may include one or more SliceInfo, and each SliceInfo may include at least one of nsag-IdentityInfo, nsag-CellReselectionPriority, nsag-CellReselectionSubPriority, and sliceCellList. In detail, SIB16 may broadcast information as in Table 6 below.

TABLE 6

| | |
|---|---|
| SIB16-r17 ::= | SEQUENCE { |
| freqPriorityListSlicing-r17 | FreqPriorityListSlicing-r17 |

OPTIONAL, -- Need R

| | |
|---|---|
| lateNonCriticalExtension | OCTET STRING |

```
  OPTIONAL,
        ...
}
FreqPriorityListSlicing-r17 ::= SEQUENCE (SIZE
  (1..maxFreqPlus1)) OF FreqPrioritySlicing-r17
```

| | |
|---|---|
| FreqPrioritySlicing-r17 ::= | SEQUENCE { |
| dl-ImplicitCarrierFreq-r17 | INTEGER (0..maxFreq), |
| sliceInfoList-r17 | SliceInfoList-r17 |

OPTIONAL -- Need R
}

| | |
|---|---|
| SliceInfoList-r17 ::= | SEQUENCE (SIZE |

(1..maxSliceInfo-r17)) OF SliceInfo-r17

| | |
|---|---|
| SliceInfo-r17 ::= | SEQUENCE { |
| nsag-IdentityInfo-r17 | NSAG-IdentityInfo- |

```
  r17,
        nsag-CellReselectionPriority-r17 CellReselectionPriority
  OPTIONAL, -- Need R
        nsag-CellReselectionSubPriority-r17
  CellReselectionSubPriority
  OPTIONAL, -- Need R
```

| | |
|---|---|
| sliceCellListNR-r17 | CHOICE { |

```
            sliceAllowedCellListNR-r17 SliceCellListNR-r17,
            sliceExcludedCellListNR-r17 SliceCellListNR-r17
          }
    OPTIONAL -- Need R
  }
```

| | |
|---|---|
| SliceCellListNR-r17 ::= | SEQUENCE (SIZE |

(1..maxCellSlice-r17)) OF PCI-Range

FreqPrioritySlicing field descriptions

```
    dl-ImplicitCarrierFreq
    Indicates the downlink carrier frequency to which sliceInfoList is
      associated with. The frequency is signalled implicitly, value 0
      corresponds to the serving frequency, value 1 corresponds to
      the first frequency indicated by the InterFreqCarrierFreqList in
      SIB4, and value 2 coresponds to the second frequency indicated
      by the InterFreqCarrierFreqList in SIB4, and so on.
```

SliceInfo field descriptions

```
    nsag-IdentityInfo
    This is the NSAG identifier of the NSAG.
    sliceAllowedCellListNR
    List of allow-listed neighbouring cells for slicing. If present, cells
      not listed in this list do not support the corresponding nsag-
      frequency pair, according to 38.304 [20], clause 5.2.4.11.
    sliceCellListNR
    Contains either the list of allow-listed or exclude-listed
      neighbour cells for slicing.
    sliceExcludedCellListNR
    List of exclude-listed neighbouring cells for slicing. If present,
      cells not listed in this list support the corresponding slice nsag-
      frequency pair, according to 38.304 [20], clause 5.2.4.11,
```

In the disclosure, cell reselection priority information broadcast by SIB2, SIB4, and SIB5 may be referred to as conventional cell reselection priority information, and cell reselection priority information broadcast by SIB16 may be referred to as slice cell reselection priority information.

In operation 1f-40, the UE 1f-01 in the RRC idle mode or the RRC inactive mode may derive a reselection priority for slice-based cell reselection. When cellReselectionPriorities is configured in the RRC connection release message, a reselection priority may be derived by applying cellReselectionPriorities as described above. That is, the UE may ignore a reselection priority broadcast via system information. On the other hand, when cellReselectionPriorities of the RRC connection release message is not applied as described above, a reselection priority may be derived by applying reselection priority information broadcast via system information. In detail, the UE may derive a reselection priority according to the following rules.
Frequencies that support at least one prioritized NSAG received from NAS have higher re-selection priority than frequencies that support none of the NSAG(s) received from NAS.
Frequencies that support at least one NSAG provided by NAS are prioritised in the order of the NAS-provided priority for the NSAG with highest priority supported on the frequency. For example, when NSAG1 and NSAG2 are supported in a specific frequency but an NSAG1 priority value (provided by a NAS) is 3 and an NSAG2 priority value is 1, the frequency may be prioritized according to the NSAG1 priority value.
Among the frequencies (one or multiple) that support the highest prioritized NSAG(s) with the same NAS-provided priorities, the frequencies are prioritized in the order of their highest nsag-CellReselectionPriority given for these NSAG(s). For example, when frequency 1 supports NSAG 1 (NSAG 1 priority value is 2) and frequency 2 supports NSAG 2 (NSAG 2 priority value is 2), nsag-CellReselectionPriority for NSAG1 is broadcast as 3 in frequency 1, and nsag-CellReselectionPriority for NSAG2 is broadcast as 2 in frequency 2, frequency 1 may be prioritized over frequency 2.
Frequencies that support an NSAG provided by NAS and that indicate nsag-CellReselectionPriority for the NSAG have higher re-selection priority than frequencies that support this prioritized NSAG without indicating nsag-CellReselectionPriority for the NSAG.-Frequencies that support an NSAG provided by NAS and that indicate nsag-CellReselectionPriority (greater than 0) and/or nsag-CellReselectionSubPriority (greater than 0) have higher re-selection priority than frequencies that support this prioritized NSAG without indicating nsag-CellReselectionPriority and/or nsag-CellReselectionSubPriority for the NSAG.
Frequencies that support none of the NSAG(s) provided by NAS are prioritized in the order of their cellReselectionPriority and/or cellReselectionSubPriority.

For reference, the UE considers an NR frequency to support all slices of an NSAG if
the corresponding nsag-ID is indicated for the NR frequency and valid for current TA.

In operation 1f-45, the UE 1f-01 in the RRC idle mode or the RRC inactive state may perform frequency measurement for cell reselection. In this case, in order to minimize battery consumption, the UE 1f-01 may perform frequency measurement by using measurement rules below, according to the cell reselection priority determined in operation 1f-40.
When condition 1 below is satisfied, the UE may not perform NR intra-frequency measurement. Otherwise (e.g., when condition 1 below is not satisfied), the UE performs NR intra-frequency measurement.
Condition 1: A reception level (Srxlev) of the serving cell is greater than a threshold value of SintraSearchP, and a reception quality (Squal) of the serving cell is greater than SIntraSearchQ (Serving cell fulfils Srxlev>SIntraSearchP and Squal>SIntraSearchQ).
For NR inter-frequency or inter-RAT frequency of which cell reselection priority is higher than the NR frequency of the current serving cell, the UE may perform measurement according to 3GPP TS 38.133 rules.
For an NR inter-frequency of which cell reselection priority is equal to or lower than the NR frequency of the current serving cell and an inter-RAT frequency of which cell reselection priority is lower than the NR frequency of the current serving cell, the UE may not perform measurement when condition 2 below is satisfied. Otherwise (e.g., when condition 2 below is not satisfied), the UE may measure cells in an NR inter-frequency of which cell reselection priority is equal to or lower than the NR frequency or may measure cells in an inter-RAT frequency of which cell reselection priority is lower than the NR frequency.
Condition 2: A reception level (Srxlev) of the serving cell is greater than a threshold value of SnonIntraSearchP, and a reception quality (Squal) of the serving cell is greater than SnonIntraSearchQ (Serving cell fulfils Srxlev>SnonIntraSearchP and Squal>SnonIntraSearchQ).

For reference, the aforementioned threshold values (SintraSearchP, SintraSearchQ and SnonIntraSearchP SnonintraSearchQ) may be broadcast by the system information obtained in operation 1h-20.

In operation 1f-50, the UE 1f-01 in the RRC idle mode or the RRC inactive state may determine to reselect a cell fulfilling cell reselection criteria, based on a value of the measurement performed in operation 1f-45. The cell reselection criteria may vary according to cell reselection priorities. Cell reselection to a higher priority RAT/frequency shall take precede over a lower priority RAT/frequency if multiple cells of different priorities fulfil the cell reselection criteria. In detail, operations of the UE with respect to cell reselection criteria for inter-frequency/inter-RAT cell having a higher priority than a frequency of the current serving cell are as follows.
First operation:
If SIB2 includes and broadcasts a threshold value with respect to threshServingLowQ and 1 second has elapsed after the UE camps on the current serving cell, when a signal quality (Squal) of inter-frequency/inter-RAT cell is greater than a threshold value ThreshX, HighQ during a particular time interval TreselectionRAT (Squal>ThreshX, HighQ during a time interval TreselectionRAT), the UE may perform reselection to the inter-frequency/inter-RAT cell.
Second operation:
When the UE cannot perform the first operation, the UE performs the second operation.
When 1 second has elapsed after the UE camps on the current serving cell and a reception level (Srxlev) of inter-frequency/inter-RAT cell is greater than a threshold value ThreshX, HighP during a particular time interval TreselectionRAT (Srxlev>ThreshX, HighP during a time interval Treselection-RAT-), the UE may perform reselection to the inter-frequency/inter-RAT cell.

Here, the UE performs the first operation or the second operation, based on a signal quality (Squal), a reception level (Srxlev), threshold values (ThrehX, HighQ, and ThreshX, HighP), and TreselectionRAT value information of an inter-frequency cell which are included in SIB4 being broadcast from the serving cell, and performs the first operation or the second operation, based on a signal quality (Squal), a reception level (Srxlev), threshold values (ThreshX, HighQ, ThreshX, and HighP), and TreselectionRAT value information of an inter-RAT cell which are included in SIB5 being broadcast from the serving cell. For example, SIB4 includes a Qqualmin value or a Qrxlevmin value, and the UE derives the signal quality (Squal) or the reception level (Srxlev) of the inter-frequency cell, based on the value of SIB4. If a plurality of cells that fulfill a high cell reselection priority exist in an NR frequency, the UE may reselect a highest ranked cell from among cells that fulfill reselection criteria of intra-frequency/inter-frequency cells having the same priority as a frequency of the current serving cell.

Also, operations of the UE with respect to the reselection criteria of intra-frequency/inter-frequency cells having the same priority as a frequency of the current serving cell are as follows.
Third operation:
When a signal quality (Squal) and a reception level (Srxlev) of intra-frequency/inter-frequency cells are greater than 0, the UE derives a rank for each cell, based on a measurement value (RSRP) (The UE shall perform ranking of all cells that fulfils the cell selection criterion S). Ranks of the serving cell and a neighboring cell are calculated by using Equation 2 below.

$${R}_{s} = {Q}_{meas , s} + {Q}_{hyst} \qquad [ Equation 2 ]$$

$${R}_{n} = {Q}_{meas , n} - Qoffset$$

<<img1>>Here, Qmeas,s is an RSRP measurement value of the serving cell, Qmeas,n is an RSRP measurement value of the neighboring cell, Qhyst is a hysteresis value of the serving cell, and Qoffset is an offset between the serving cell and the neighboring cell. SIB2 includes a value of Qhyst, and the value is commonly used in reselection of intra-frequency/inter-frequency cells. In a case of reselection of an intra-frequency cell, Qoffset is signaled for each cell, is applied only to a designated cell, and is included in SIB3. In a case of reselection of an inter-frequency cell, Qoffset is signaled for each cell, is applied only to a designated cell, and is included in SIB4. When a rank of the neighboring cell which is calculated by using Equation 2 is greater than a rank of the serving cell (R−n>Rs), reselection is performed on an optimal cell from among neighboring cells.

Also, operations of the UE with respect to the reselection criteria of inter-frequency/inter-RAT cells having a lower priority than the frequency of the current serving cell are as follows.
Fourth operation:
If SIB2 includes and broadcasts a threshold value with respect to threshServingLowQ and 1 second has elapsed after the UE camps on the current serving cell, when a signal quality (Sqaul) of the current serving cell is lower than a threshold value ThreshServing, LowQ (Squal<ThreshServing, LowQ), and a signal quality (Squal) of inter-frequency/inter-RAT cell is greater than a threshold value ThreshX, LowQ-during a particular time interval TreselectionRAT (Squal>ThreshX, LowQ during a time interval TreselectionRAT), the UE may perform reselection to the inter-frequency/inter-RAT cell.
Fifth operation:
When the UE cannot perform the fourth operation, the UE performs the fifth operation.
When 1 second has elapsed after the UE camps on the current serving cell and a reception level (Srxlev) of the current serving cell is lower than a threshold value ThreshServing, LowP (Srxlev<ThreshServing, LowP), and a reception level (Srxlev) of inter-frequency/inter-RAT cell is greater than a threshold value ThreshX, LowQ-during a particular time interval TreselectionRAT (Srxlev>ThreshX, LowP during a time interval TreselectionRAT), the UE may perform reselection to the inter-frequency/inter-RAT.

Here, the UE performs the fourth operation or the fifth operation with respect to an inter-frequency cell, based on threshold values (ThreshServing, LowQ, ThreshServing, and LowP) included in SIB2 being broadcast from the serving cell and a signal quality (Squal), a reception level (Srxlev), threshold values (ThrehX, LowQ, ThreshX, and LowP), and TreselectionRAT of the inter-frequency cell which are included in SIB4 being broadcast from the serving cell, and performs the fourth operation or the fifth operation with respect to an inter-RAT cell, based on threshold values (ThreshServing, LowQ, ThreshServing, and LowP) included in SIB2 being broadcast from the serving cell and a signal quality (Squal), a reception level (Srxlev), threshold values (ThreshX,LowQ, ThreshX, and LowP), and TreselectionRAT of the inter-RAT cell which are included in SIB5 being broadcast from the serving cell. For example, SIB4 includes a Qqualmin value or a Qrxlevmin value, the UE derives the signal quality (Squal) or the reception level (Srxlev) of the inter-frequency cell, based on the value of SIB4. If a plurality of cells that fulfill a high cell reselection priority exist in an NR frequency, the UE may reselect a highest ranked cell from among cells that fulfill reselection criteria of intra-frequency/inter-frequency cells having the same priority as a frequency of the current serving cell. If one candidate cell is derived by satisfying the above conditions in a frequency having a priority higher or lower than the frequency of the current serving cell, the UE may reselect the cell as a best cell.

The UE performing slice-based cell reselection according to an embodiment of the disclosure may additionally determine whether a best cell or a highest ranked cell satisfying the above cell reselection criteria in operation 1f-50 in a specific frequency supports a corresponding NSAG, based on the reselection priority for the NSAG and frequency derived according to operation 1f-40. In detail, the UE may consider a cell on an NR frequency to support all slices of an NSAG if
the corresponding nsag-ID is indicated for the NR frequency and valid for current TA; and
the cell is either listed in the sliceAllowedCellListNR (if provided in the used slice specific cell reselection information) or the cell is not listed in the sliceExcludedCellListNR (if provided in the used slice specific cell reselection information); or
neither sliceAllowedCellListNR nor sliceExcludedCellListNR is configured in the used slice specific cell reselection information

If a best cell or highest ranked cell in a frequency fulfils the cell reselection criteria in 1f-50 for cell reselection based on re-selection priority for the frequency and NSAG derived according to 1f-40 but this cell does not support the NSAG as described above, the UE shall re-derive a re-selection priority for the frequency by considering the NSAG(s) supported by this cell (best or highest ranked cell) (rather than those of the corresponding NR frequency) according to 1f-40. This reselection priority may be used for a maximum of 300 seconds, or until new information of NSAG(s) and their priorities are received from NAS. The UE shall ensure the cell reselection criteria above are fulfilled based on newly derived priorities.

In operation 1f-55, the UE 1f-01 in the RRC idle mode or the RRC inactive state receives system information (e.g., MIB or SIB1) broadcast from a candidate target cell before the UE 1f-01 finally reselects the candidate target cell, and determines, based on the system information, whether a reception level (Srxlev) and a reception quality (Squal) of the candidate target cell fulfill (Srxlev>0 AND Squal>0) cell selection criterion referred to as S-criterion (Equation 1). When Equation 1 is fulfilled and the candidate target cell is suitable, the UE may reselect the candidate target cell.

FIG. 1G is a diagram illustrating a process in which a UE supporting slice-based cell reselection receives a paging message including slice information from a BS in a wireless communication system, according to an embodiment of the disclosure.

Referring to FIG. 1G, a UE 1g-01 supporting slice-based cell reselection may be in an RRC connected mode (RRC_CONNECTED) by establishing RRC connection with an NR BS 1g-02 (1g-05).

In operation 1g-10, the UE 1g-01 may transmit a UE capability information message (UECapabilityInformation) to the NR BS 1g-02. The UE capability information message may include the following information.
Indicator indicating the capability to understand slice information included in a paging record for the UE in a paging message

In operation 1g-15, the UE 1g-01 may transmit a NAS message to an AMF 1g-03. For example, the NAS message may refer to a registration request or a service request. The NAS message may include the following information.
Indicator indicating the capability to understand slice information included in a paging record for the UE in a paging message

In operation 1g-20, the NR BS 1g-02 may transmit an RRC connection release message (RRCRelease) to the UE 1g-01.

In operation 1g-25, the UE 1g-02 may transition to an RRC idle mode (RRC_IDLE) or an RRC inactive mode (RRC_INACTIVE). When suspend configuration information (suspendConfig) is included in the RRC connection release message received in operation 1g-20, the UE may transition to an RRC inactive mode. Otherwise, the UE may transition to an RRC idle mode.

In operation 1g-30, the UE 1g-01 may receive a RAN paging message (RAN-initiated paging) initiated by the NR BS 1g-02, or in operation 1g-35, the UE 1g-01 may receive a core network paging message (CN-initiated paging) initiated by the AMF 1g-03. When the UE is in the RRC inactive mode, the UE may monitor and receive RAN-initiated paging or CN-initiated paging, and when the UE is in the RRC idle mode, the UE may monitor and receive CN-initiated paging. For reference, when the UE receives CN-initiated paging in the RRC inactive mode, the UE may transition to the RRC idle mode. Because the UE may not know which slice service to provide when receiving a paging message, the disclosure proposes that the paging message may include slice information for each paging record by using at least one of the following methods.
Method 1: A paging message may be configured by defining a new pagingRecordList that may include slice information, in the same order as a previously defined pagingRecordList (the underlined part in Table 7 indicates Method 1). For example, when the previously defined pagingRecordList includes three pagingRecords (e.g., PagingUE-Identity 1, PagingUE-Identity 2, and PagingUE-Identity 3), slice information (nsag-IdentityInfo) may be included in each pagingRecord in the same order. For reference, the slice information may include nsag-IdentityInfo, may include nsag-Id, or may include a 1-bit indicator (e.g., indicating whether a current cell supports a slice service due to the paging message). Also, the slice information for each paging record may be included only when a cell transmitting the paging message does not support the slice information or only when supports the slice information, which may be determined according to an operating method of the BS. The feature of Method 1 is that when slice information should be included in at least one paging record, the new pagingRecordList should always be included in the paging message.

TABLE 7

| Paging ::= | SEQUENCE { |
|---|---|
| pagingRecordList | PagingRecordList OPTIONAL, |
| -- Need N | |
| lateNonCriticalExtension | OCTET STRING |
| OPTIONAL, | |
| nonCriticalExtension | Paging-v1700-IEs OPTIONAL |
| } | |
| Paging-v1700-IEs ::= | SEQUENCE { |
| pagingRecordList-v1700 PagingRecordList-v1700 | |
| OPTIONAL, -- Need N | |
| pagingGroupList-r17 PagingGroupList-r17 | |
| OPTIONAL, | |
| nonCriticalExtension SEQUENCE {Paging-v18xy-IEs} | |
| OPTIONAL | |
| } | |
| Paging-v18xy-IEs ::= SEQUENCE { | |
| pagingRecordList-v18xy PagingRecordList-v18xy | |
| OPTIONAL, -- Need N | |
| nonCriticalExtension SEQUENCE { } OPTIONAL | |
| } | |
| PagingRecordList ::= | SEQUENCE |
| (SIZE(1..maxNrofPageRec)) OF PagingRecord | |
| PagingRecordList-v1700 ::= | SEQUENCE |
| (SIZE(1..maxNrofPageRec)) OF PagingRecord-v1700 | |
| PagingRecordList-v18xy ::= SEQUENCE | |
| (SIZE(1..maxNrofPageRec)) OF PagingRecord-v18xy | |
| PagingGroupList-r17 ::= | SEQUENCE |
| (SIZE(1..maxNrofPageGroup-r17)) OF TMGI-r17 | |
| PagingRecord ::= | SEQUENCE { |
| ue-Identity | PagingUE-Identity, |
| accessType | ENUMERATED {non3GPP} |
| OPTIONAL, -- Need N | |
| ... | |
| } | |
| PagingRecord-v1700 ::= | SEQUENCE { |
| pagingCause-r17 | ENUMERATED {voice} |
| OPTIONAL -- Need N | |
| } | |
| PagingUE-Identity ::= | CHOICE { |
| ng-5G-S-TMSI | NG-5G-S-TMSI, |
| fullI-RNTI | I-RNTI-Value, |
| ... | |
| } | |
| PagingRecord-v18xy ::= SEQUENCE { | |
| nsag-IdentityInfo-r17 NSAG-IdentityInfo- | |
| r17 OPTIONAL -- Need R | |
| } | |
| NSAG-IdentityInfo-r17 ::= | SEQUENCE { |
| nsag-ID-r17 | NSAG-ID-r17, |
| trackingAreaCode- | |
| r17 TrackingAreaCode OPTIONAL | |
| -- Need R | |
| } | |
| NSAG-ID-r17 ::= | BIT STRING (SIZE (8)) |

Method 2: A paging message may be configured by defining a new pagingRecordListforSlice separate from a previously defined pagingRecordList. The new pagingRecordListforSlice may include one or more pagingRecords including slice information (the underlined part in Table 8 indicates Method 2). That is, a pagingRecord not including slice information may be included in the previously defined pagingRecordList and a paging Record including slice information may be included in the new pagingRecordListforSlice. For reference, the slice information may include nsag-IdentityInfo, may include only nsag-Id, or may include a 1-bit indicator (e.g., indicating whether a current cell supports a slice service due to the paging message). Also, the slice information for each paging record may be included only when a cell transmitting the paging message does not support the slice information or only when supports the slice information, which may be determined according to an operating method of the BS. The advantage of Method 2 is that information included in the paging message may be efficiently signaled by separately operating a paging record list including slice information and a paging record list not including slice information.

TABLE 8

| Paging ::= | SEQUENCE { |
|---|---|
| pagingRecordList | PagingRecordList OPTIONAL, |
| -- Need N | |
| lateNonCriticalExtension | OCTET STRING |
| OPTIONAL, | |
| nonCriticalExtension | Paging-v1700-IEs OPTIONAL |
| } | |
| Paging-v1700-IEs ::= | SEQUENCE { |
| pagingRecordList-v1700 PagingRecordList-v1700 | |
| OPTIONAL, -- Need N | |
| pagingGroupList-r17 PagingGroupList-r17 | |
| OPTIONAL, | |
| nonCriticalExtension SEQUENCE {Paging-v18xy-IEs} | |
| OPTIONAL | |
| } | |
| Paging-v18xy-IEs ::= SEQUENCE { | |
| pagingRecordListforSlice-v18xy PagingRecordListforSlice-v18xy | |
| OPTIONAL, -- Need N | |
| nonCriticalExtension SEQUENCE { } OPTIONAL | |
| } | |
| PagingRecordList ::= | SEQUENCE |
| (SIZE(1..maxNrofPageRec)) OF PagingRecord | |
| PagingRecordList-v1700 ::= | SEQUENCE |
| (SIZE(1..maxNrofPageRec)) OF PagingRecord-v1700 | |
| PagingRecordListforSlice-v18xy ::= SEQUENCE | |
| (SIZE(1..maxNrofPageRec)) OF PagingRecord-r18 | |
| PagingGroupList-r17 ::= | SEQUENCE |
| (SIZE(1..maxNrofPageGroup-r17)) OF TMGI-r17 | |
| PagingRecord ::= | SEQUENCE { |
| ue-Identity | PagingUE-Identity, |
| access Type | ENUMERATED {non3GPP} |
| OPTIONAL, -- Need N | |
| ... | |
| } | |
| PagingRecord-v1700 ::= | SEQUENCE { |
| pagingCause-r17 | ENUMERATED {voice} |
| OPTIONAL -- Need N | |
| } | |
| PagingUE-Identity ::= | CHOICE { |
| ng-5G-S-TMSI | NG-5G-S-TMSI, |
| fullI-RNTI | I-RNTI-Value, |
| ... | |
| } | |
| PagingRecord-r18 ::= SEQUENCE { | |
| ue-Identity PagingUE-Identity, | |
| accessType ENUMERATED {non3GPP} | |
| OPTIONAL, -- Need N | |
| nsag-IdentityInfo-r17 NASG-IdentityInfo-r17 | |
| } | |
| NSAG-IdentityInfo-r17 ::= | SEQUENCE { |
| nsag-ID-r17 | NSAG-ID-r17, |
| trackingAreaCode- | |
| r17 TrackingAreaCode OPTIONAL | |
| -- Need R | |
| } | |
| NSAG-ID-r17 ::= | BIT STRING (SIZE (8)) |

Method 3: A paging message may be configured by defining a new pagingRecordListforSlice separate from a previously defined pagingRecordList and introducing a UE identification index for each paging record. The new pagingRecordListforSlice may include one or more pagingRecords including slice information (the underlined part in Table 9 indicates Method 3). In this case, an identifier (ue-IdentityIndex) indicating the UE for each pagingRecord may be based on the conventional pagingRecordList. For example, when the previously defined pagingRecordList includes three pagingRecords (e.g., PagingUE-Identity 1, PagingUE-Identity 2, and PagingUE-Identity 3), ue-IdentityIndex=3 may indicate PagingUE-Identity 3. A pagingRecord including slice information may be included in the new pagingRecordListforSlice. For reference, the slice information may include nsag-IdentityInfo, may include only nsag-Id, or may include a 1-bit indicator (e.g., indicating whether a current cell supports a slice service due to the paging message). Also, the slice information for each paging record may be included only when a cell transmitting a paging message does not support the slice information or only when supports the slice information, which may be determined according to an operating method of the BS. The advantage of Method 3 is that when a paging record list including slice information is small, the overhead of information included in the paging message may be reduced, thereby efficiently performing signaling.

TABLE 9

| | |
|---|---|
| Paging ::= | SEQUENCE { |
| pagingRecordList | PagingRecordList OPTIONAL, |

-- Need N

| | |
|---|---|
| lateNonCriticalExtension | OCTET STRING |

OPTIONAL,

| | |
|---|---|
| nonCriticalExtension | Paging-v1700-IEs OPTIONAL |

}

| | |
|---|---|
| Paging-v1700-IEs ::= | SEQUENCE { |

```
    pagingRecordList-v1700 PagingRecordList-v1700
  OPTIONAL, -- Need N
    pagingGroupList-r17 PagingGroupList-r17
  OPTIONAL,
    nonCriticalExtension SEQUENCE {Paging-v18xy-IEs}
  OPTIONAL
}
Paging-v18xy-IEs ::= SEQUENCE {
    pagingRecordListforSlice-v18xy PagingRecordListforSlice-v18xy
  OPTIONAL, -- Need N
      nonCriticalExtension SEQUENCE { } OPTIONAL
}
```

| | |
|---|---|
| PagingRecordList ::= | SEQUENCE |

(SIZE(1..maxNrofPageRec)) OF PagingRecord

| | |
|---|---|
| PagingRecordList-v1700 ::= | SEQUENCE |

```
  (SIZE(1..maxNrofPageRec)) OF PagingRecord-v1700
PagingRecordListforSlice-v18xy ::= SEQUENCE
  (SIZE(1..maxNrofPageRec)) OF PagingRecord-r18
```

| | |
|---|---|
| PagingGroupList-r17 ::= | SEQUENCE |

(SIZE(1..maxNrofPageGroup-r17)) OF TMGI-r17

| | |
|---|---|
| PagingRecord ::= | SEQUENCE { |
| ue-Identity | PagingUE-Identity, |
| accessType | ENUMERATED {non3GPP} |

```
  OPTIONAL, -- Need N
    ...
}
```

| | |
|---|---|
| PagingRecord-v1700 ::= | SEQUENCE { |
| pagingCause-r17 | ENUMERATED {voice} |

OPTIONAL -- Need N
}

| | |
|---|---|
| PagingUE-Identity ::= | CHOICE { |
| ng-5G-S-TMSI | NG-5G-S-TMSI, |
| fullI-RNTI | I-RNTI-Value, |

```
    ...
}
PagingRecord-r18 ::= SEQUENCE {
      ue-Identity Index INTEGER (1..maxNrofPageRec)
      nsag-IdentityInfo-r17 NASG-IdentityInfo-r17
}
```

| | |
|---|---|
| NSAG-IdentityInfo-r17 ::= | SEQUENCE { |
| nsag-ID-r17 | NSAG-ID-r17, |

```
    trackingAreaCode-
  r17 TrackingAreaCode OPTIONAL
  -- Need R
}
```

| | |
|---|---|
| NSAG-ID-r17 ::= | BIT STRING (SIZE (8)) |

For reference, the UE may forward the slice information to upper layers when receiving the paging message.

FIG. 1H is a diagram illustrating a process in which a UE supporting slice-based cell reselection receives a paging message including slice information from a BS in a wireless communication system, according to an embodiment of the disclosure.

Referring to FIG. 1H, a UE 1h-01 supporting slice-based cell reselection may be in an RRC connected mode (RRC_CONNECTED) by establishing RRC connection with an NR BS 1h-02 (1h-05).

In operation 1h-10, the UE 1h-01 may transmit a UE capability information message (UECapabilityInformation) to the NR BS 1h-02. The UE capability information message may include the following information.
Indicator indicating the capability to understand slice information included in a paging record for the UE in a paging message

In operation 1h-15, the UE 1h-01 may transmit a NAS message to an AMF 1h-03. For example, the NAS message may refer to a registration request or a service request. The NAS message may include the following information.
Indicator indicating the capability to understand slice information included in a paging record for the UE in a paging message

In operation 1h-20, the NR BS 1h-02 may transmit an RRC connection release message (RRCRelease) to the UE 1h-01.

In operation 1h-25, the UE 1h-02 may transition to an RRC idle mode (RRC_IDLE) or an RRC inactive mode (RRC_INACTIVE). When suspend configuration information (suspendConfig) is included in the received RRC connection release message in operation 1h-20, the UE may transition to an RRC inactive mode. Otherwise, the UE may transition to an RRC idle mode.

In operation 1h-30, the UE 1h-01 may receive a RAN paging message (RAN-initiated paging) initiated by the NR BS 1h-02, or in operation 1h-35, the UE 1h-01 may receive a core network paging message (CN-initiated paging) initiated by the AMF 1h-03. When the UE is in the RRC inactive mode, the UE may monitor and receive RAN-initiated paging or CN-initiated paging, and when the UE is in the RRC idle mode, the UE may monitor and receive CN-initiated paging. For reference, when the UE receives CN-initiated paging in the RRC inactive mode, the UE may transition to the RRC idle mode. Because the UE may not know which slice service to provide when receiving a paging message, the disclosure proposes that the paging message may include slice information for each paging record list.
Method: A paging message may be configured by defining a paging record list (pagingRecordListperSlice) for each slice information. That is, it may mean that paging records mapped to a specific slice may be configured as one list. In detail, one or more paging records for a specific slice may be included in a paging message. Each paging record may include at least one of ue-Identity and accessType. The description of slice information may be the same as that made in the above embodiment. For reference, the UE may forward the slice information to upper layers when receiving the paging message.

FIG. 1I is a diagram illustrating a process in which a UE supporting slice-based cell reselection receives a paging message including slice information from a BS in a wireless communication system, according to an embodiment of the disclosure.

Referring to FIG. 1I, a UE 1i-01 supporting slice-based cell reselection may be in an RRC connected mode (RRC_CONNECTED) by establishing RRC connection with an NR BS 1i-02 (1i-05).

In operation 1i-10, the UE 1i-01 may transmit a UE capability information message (UECapabilityInformation) to the NR BS 1i-02. The UE capability information message may include the following information.
Indicator indicating the capability to understand slice information included in a paging record for the UE in a paging message

In operation 1i-15, the UE 1i-01 may transmit a NAS message to an AMF 1i-03. For example, the NAS message may refer to a registration request or a service request. The NAS message may include the following information.
Indicator indicating the capability to understand slice information included in a paging record for the UE in a paging message

In operation 1i-20, the NR BS 1i-02 may transmit an RRC connection release message (RRCRelease) to the UE 1i-01.

In operation 1i-25, the UE 1i-02 may transition to an RRC idle mode (RRC_IDLE) or an RRC inactive mode (RRC_INACTIVE). When suspend configuration information (suspendConfig) is included in the received RRC connection release message in operation 1i-20, the UE may transition to an RRC inactive mode. Otherwise, the UE may transition to an RRC idle mode.

In operation 1i-30, the UE 1i-01 may receive a RAN paging message (RAN-initiated paging) initiated by the NR BS 1i-02, or in operation 1i-35, the UE 1i-01 may receive a core network paging message (CN-initiated paging) initiated by the AMF 1i-03. A paging message may be configured by applying at least one of the above embodiments.

In operation 1i-40, when slice information of a paging record indicating the UE is included in the paging message, the UE 1i-01 may determine frequencies supporting the slice information as a highest reselection priority. Alternatively, when slice information of a paging record indicating the UE is included in the paging message, the UE 1i-01 may determine a slice as a highest NSAG priority (e.g., a highest NSAG priority different from an NSAG priority set by an AMF). A cell reselection procedure may be performed according to the above embodiment (FIG. 1E). For reference, operation 1i-30 or operation 1i-35 may be performed only when the UE 1i-01 does not support slice information in a paging record indicated for the UE by a current serving cell, and the UE 1i-01 may perform operation 1i-40.

In operation 1i-45, the UE 1i-01 may perform a random access procedure. That is, an RRC establishment procedure or an RRC resume procedure may be performed. The UE 1i-01 may perform a random access procedure by using slice-specific RACH configuration associated with the slice information in the paging record indicating the UE. The slice-specific RACH configuration is based on system information.

FIG. 1J is a diagram illustrating a process in which a UE supporting slice-based cell reselection receives a paging message including slice information from a BS in a wireless communication system, according to an embodiment of the disclosure.

Referring to FIG. 1J, a UE 1j-01 supporting slice-based cell reselection may be in an RRC connected mode (RRC_CONNECTED) by establishing RRC connection with an NR BS 1j-02 (1j-05).

In operation 1j-10, the UE 1j-01 may transmit a UE capability information message (UECapabilityInformation) to the NR BS 1j-02. The UE capability information message may include the following information.
Indicator indicating the capability to understand slice information included in a paging record for the UE in a paging message

In operation 1j-15, the UE 1j-01 may transmit a NAS message to an AMF 1j-03. For example, the NAS message may refer to a registration request or a service request. The NAS message may include the following information.
Indicator indicating the capability to understand slice information included in a paging record for the UE in a paging message

In operation 1j-20, the NR BS 1j-02 may transmit an RRC connection release message (RRCRelease) to the UE 1j-01. A new timer value may be configured in the RRC connection release message. The UE may run a new timer with the new timer value when receiving a paging message. While the new timer is running, the UE may perform selection or reselection to a cell supporting slice information indicated in the paging message.

In operation 1j-25, the UE 1j-02 may transition to an RRC idle mode (RRC_IDLE) or an RRC inactive mode (RRC_INACTIVE). When suspend configuration information (suspendConfig) is included in the received RRC connection release message in operation 1j-20, the UE may transition to an RRC inactive mode. Otherwise, the UE may transition to an RRC idle mode.

In operation 1j-27, the UE 1j-01 may obtain system information broadcast by the NR BS 1j-02. A new timer value may be broadcast in the system information. The UE may run a new timer with the new timer value when receiving a paging message. While the new timer is running, the UE may perform selection or reselection to a cell supporting slice information indicated in the paging message.

In operation 1j-30, the UE 1j-01 may receive a RAN paging message (RAN-initiated paging) initiated by the NR BS 1j-02, or in operation 1j-35, the UE 1j-01 may receive a core network paging message (CN-initiated paging) initiated by the AMF 1j-03. A paging message may be configured by applying at least one of the above embodiments.

In operation 1j-40, when slice information of a paging record indicating the UE is included in the paging message, the UE 1i-01 may determine frequencies supporting the slice information as a highest reselection priority. Alternatively, when slice information of a paging record indicating the UE is included in the paging message, the UE may determine a slice as a highest NSAG priority. A cell reselection procedure may be performed according to the above embodiment (FIG. 1E). For reference, operation 1j-30 or operation 1j-35 may be performed only when the UE does not support slice information in a paging record indicated for the UE by a current serving cell, and the UE may perform operation 1j-40. Alternatively, in operation 1j-40, when the UE does not support slice information in a paging record indicated for the UE by a current serving cell, the UE may run a new timer with a new timer value and may perform cell selection or reselection only until the new timer expires. The UE may perform operation 1j-45 upon cell selection or reselection (of course, the UE may also perform operation 1j-45 in a current camping cell without cell selection or reselection). When the UE fails to select or reselect a cell supporting slice information until the new timer expires, the UE may perform operation 1j-45 in a current cell. For reference, the new timer value may be pre-defined.

In operation 1j-45, the UE may perform a random access procedure. That is, an RRC establishment procedure or an RRC resume procedure may be performed. The UE may perform a random access procedure by using slice-specific RACH configuration associated with the slice information in the paging record indicating the UE. The slice-specific RACH configuration is based on the system information.

FIG. 1K is a diagram illustrating a process in which a UE supporting slice-based cell reselection receives a paging message including slice information from a BS in a wireless communication system, according to an embodiment of the disclosure.

Referring to FIG. 1K, a UE 1k-01 supporting slice-based cell reselection may be in an RRC connected mode (RRC_CONNECTED) by establishing RRC connection with an NR BS 1k-02 (1k-05).

In operation 1k-10, the UE 1k-01 may transmit a UE capability information message (UECapabilityInformation) to the NR BS 1k-02. The UE capability information message may include the following information.
Indicator indicating the capability to understand slice information included in a paging record for the UE in a paging message

In operation 1k-15, the UE 1k-01 may transmit a NAS message to an AMF 1k-03. For example, the NAS message may refer to a registration request or a service request. The NAS message may include the following information.
Indicator indicating the capability to understand slice information included in a paging record for the UE in a paging message

In operation 1k-20, the NR BS 1k-02 may transmit an RRC connection release message (RRCRelease) to the UE 1k-01. A new timer value may be configured in the message. The UE may run a new timer with the new timer value when receiving a paging message. While the new timer is running, the UE may select a cell supporting slice information indicated in the paging message.

In operation 1k-25, the UE 1k-02 may transition to an RRC idle mode (RRC_IDLE) or an RRC inactive mode (RRC_INACTIVE). When suspend configuration information (suspendConfig) is included in the received RRC connection release message in operation 1k-20, the UE may transition to an RRC inactive mode. Otherwise, the UE may transition to an RRC idle mode.

In operation 1k-27, the UE 1k-01 may obtain system information broadcast by the NR BS 1k-02. A new timer value may be broadcast in the system information. The UE may drive a new timer with the new timer value when receiving a paging message. While the new timer is running, the UE may select a cell supporting slice information indicated in the paging message.

In operation 1k-30, the UE 1k-01 may receive a RAN paging message (RAN-initiated paging) initiated by the NR BS 1k-02, or in operation 1k-35, the UE 1k-01 may receive a core network paging message (CN-initiated paging) initiated by the AMF 1k-03. A paging message may be configured by applying at least one of the above embodiments.

In operation 1k-40, when slice information of a paging record indicating the UE is included in a paging message, the UE may select a cell supporting the slice information. That is, it means that a cell selection process is performed. Alternatively, in operation 1k-40, when the UE does not support slice information in a paging record indicated for the UE by a current serving cell, the UE may run a new timer with the new timer value and may perform cell selection only until the new timer expires. The UE may perform operation 1k-45 upon selection. When the UE fails to select a cell supporting slice information until the new timer expires, operation 1k-45 may be performed in a current cell. For reference, the new timer value may be pre-defined.

In operation 1k-45, the UE may perform a random access procedure. That is, an RRC establishment procedure or an RRC resume procedure may be performed. The UE may perform a random access procedure by using slice-specific RACH configuration associated with slice information in a paging record indicating the UE. The slice-specific RACH configuration is based on the system information.

FIG. 1L is a block diagram illustrating an internal structure of a UE, according to an embodiment of the disclosure.

Referring to FIG. 1L, the UE may include a radio frequency (RF) processor 1l-10, a baseband processor 1l-20, a storage 1l-30, and a controller 1l-40.

The RF processor 1l-10 may perform a function of transmitting and receiving a signal through a wireless channel, such as signal band conversion and amplification. That is, the RF processor 1l-10 may up-convert a baseband signal provided from the baseband processor 1l-20 into an RF band signal and transmit the RF band signal through an antenna, and may down-convert an RF band signal received through the antenna into a baseband signal. For example, the RF processor 1l-10 may include a transmission filter, a reception filter, an amplifier, a mixer, an oscillator, a digital-to-analog converter (DAC), and an analog-to-digital converter (ADC). Although only one antenna is illustrated in FIG. 1L, the UE may include a plurality of antennas. Also, the RF processor 1l-10 may include a plurality of RF chains. In addition, the RF processor 1l-10 may perform beamforming. For beamforming, the RF processor 1l-10 may adjust a phase and a magnitude of each of signals transmitted/received through a plurality of antennas or antenna elements. Also, the RF processor may perform multiple-input and multiple-output (MIMO) and may receive multiple layers when performing a MIMO operation.

The baseband processor 1l-20 may perform a conversion function between a baseband signal and a bit string according to physical layer specifications of a system. For example, during data transmission, the baseband processor 1l-20 may generate complex symbols by encoding and modulating a transmission bit string. Also, during data reception, the baseband processor 1l-20 may reconstruct a reception bit string by demodulating and decoding a baseband signal provided from the RF processor 1l-10. For example, when radio access technology follows an orthogonal frequency division multiplexing (OFDM) scheme, during data transmission, the baseband processor 1l-20 may generate complex symbols by encoding and modulating a transmission bit string, map the complex symbols to subcarriers, and then configure OFDM symbols through an inverse fast Fourier transform (IFFT) operation and cyclic prefix (CP) insertion. Also, during data reception, the baseband processor 1l-20 may segment a baseband signal provided from the RF processor 1l-10 in units of OFDM symbols, reconstruct signals mapped to subcarriers through a fast Fourier transform (FFT) operation, and then reconstruct a reception bit string through demodulation and decoding.

The baseband processor 1l-20 and the RF processor 1l-10 may transmit and receive signals as described above. Accordingly, each of the baseband processor 1l-20 and the RF processor 1l-10 may be referred to as a transmitter, a receiver, a transceiver, or a communicator. In addition, at least one of the baseband processor 1l-20 and the RF processor 1l-10 may include a plurality of communication modules to support a plurality of different radio access technologies. Also, at least one of the baseband processor 1l-20 or the RF processor 1l-10 may include different communication modules to process signals of different frequency bands. For example, the different radio access technologies may include a wireless local area network (LAN) (e.g., Institute of Electrical And Electronics Engineers (IEEE) 802.11) and a cellular network (e.g., LTE). Also, the different frequency bands may include a super-high frequency (SHF) (e.g., 2.5 GHz or 5 Ghz) band and a millimeter (mm) wave (e.g., 60 GHZ) band.

The storage 1l-30 may store basic programs, application programs, and data, e.g., configuration information, for operations of the UE. In addition, the storage 1l-30 may provide stored data at a request of the controller 1l-40.

The controller 1l-40 controls overall operations of the UE. For example, the controller 1l-40 may transmit and receive signals through the baseband processor 1l-20 and the RF processor 1l-10. Also, the controller 1l-40 may write and read data to and from the storage 1l-40. To this end, the controller 1l-40 may include at least one processor. For example, the controller 1l-40 may include a communication processor (CP) for controlling communication and an application processor (AP) for controlling an upper layer such as an application program.

FIG. 1M is a block diagram illustrating a configuration of a new radio (NR) BS, according to an embodiment of the disclosure.

As illustrated in FIG. 1M, a BS may include an RF processor 1m-10, a baseband processor 1m-20, a backhaul communicator 1m-30, a storage 1m-40, and a controller 1m-50.

The RF processor 1m-10 may perform a function of transmitting and receiving a signal through a wireless channel, such as signal band conversion and amplification. That is, the RF processor 1m-10 may up-convert a baseband signal provided from the baseband processor 1m-20 into an RF band signal and transmit the RF band signal through an antenna, and may down-convert an RF band signal received through the antenna into a baseband signal. For example, the RF processor 1m-10 may include a transmission filter, a reception filter, an amplifier, a mixer, an oscillator, a DAC, and an ADC. Although only one antenna is illustrated in FIG. 1M, a first access node may include a plurality of antennas. Also, the RF processor 1m-10 may include a plurality of RF chains. In addition, the RF processor 1m-10 may perform beamforming. For beamforming, the RF processor 1m-10 may adjust a phase and a magnitude of each of signals transmitted/received through a plurality of antennas or antenna elements. The RF processor may perform a downlink multiple-input and multiple-output (MIMO) operation by transmitting one or more layers.

The baseband processor 1m-20 may perform a conversion function between a baseband signal and a bit string according to physical layer specifications of first radio access technology. For example, during data transmission, the baseband processor 1m-20 may generate complex symbols by encoding and modulating a transmission bit string. Also, during data reception, the baseband processor 1m-20 reconstructs a reception bit string by demodulating and decoding a baseband signal provided from the RF processor 1m-10. For example, when radio access technology follows an OFDM scheme, during data transmission, the baseband processor 1m-20 may generate complex symbols by encoding and modulating a transmission bit string, map the complex symbols to subcarriers, and then configure OFDM symbols through an IFFT operation and CP insertion. Also, during data reception, the baseband processor 1m-20 may segment a baseband signal provided from the RF processor 1m-10 in units of OFDM symbols, reconstruct signals mapped to subcarriers via an FFT operation, and then reconstruct a reception bit string through demodulation and decoding from the reconstructed signals. The baseband processor 1m-20 and the RF processor 1m-10 may transmit and receive signals as described above. Accordingly, the baseband processor 1m-20 and the RF processor 1m-10 may be referred to as a transmitter, a receiver, a transceiver, a communicator, or a wireless communicator.

The backhaul communicator 1m-30 may provide an interface for communicating with other nodes in a network. That is, the backhaul communicator 1m-30 may convert a bit string transmitted from a main BS to another node, for example, an auxiliary BS or a core network, into a physical signal, and may convert a physical signal received from another node into a bit string.

The storage 1m-40 may store basic programs, application programs, and data, e.g., configuration information, for operations of the main BS. In particular, the storage 1m-40 may store, for example, information about a bearer allocated to a connected UE and a measurement result reported from the connected UE. Also, the storage 1m-40 may store criteria information used to determine whether to provide or release dual connectivity to or from the UE. The storage 1m-40 may provide stored data at a request from the controller 1m-50.

The controller 1m-50 may control overall operations of the main BS. For example, the controller 1m-50 may transmit and receive signals through the baseband processor 1m-20 and the RF processor 1m-10 or through the backhaul communicator 1m-30. Also, the controller 1m-50 may write and read data to and from the storage 1m-40. To this end, the controller 1m-50 may include at least one processor.

Methods according to the claims of the disclosure or the embodiments described in the specification may be implemented by hardware, software, or a combination of hardware and software.

When the methods are implemented by software, a computer-readable storage medium storing one or more programs (software modules) may be provided. The one or more programs stored in the computer-readable storage medium are configured to be executed by one or more processors in an electronic device. The one or more programs include instructions for allowing the electronic device to execute the methods according to the claims or the embodiments described in the specification.

The programs (e.g., software modules or software) may be stored in a random-access memory (RAM), a non-volatile memory including a flash memory, a read-only memory (ROM), an electrically erasable programmable read-only memory (EEPROM), a magnetic disc storage device, a compact disc-ROM (CD-ROM), a digital versatile disc (DVD), another optical storage device, or a magnetic cassette. Alternatively, the programs may be stored in a memory including any combination of some or all of the above storage media. Also, a plurality of constituent memories may be provided.

Also, the programs may be stored in an attachable storage device accessible through any or a combination of a communication network such as the Internet, an intranet, a local area network (LAN), a wide LAN (WLAN), a storage area network (SAN), or a combination thereof. Such a storage device may access a device according to an embodiment of the disclosure through an external port. Also, a separate storage device on a communication network may access a device according to an embodiment of the disclosure.

In specific embodiments of the disclosure described above, components included in the disclosure are expressed in a singular or plural form according to the specific embodiments of the disclosure. However, singular or plural expressions have been selected properly for a condition provided for convenience of description, and the disclosure is not limited to singular or plural components. Components expressed as plural may be configured as a single component, or a component expressed as singular may be configured as plural components.

Although specific embodiments are described in the detailed description of the disclosure, various modifications may be made without departing from the scope of the disclosure. Hence, the scope of the disclosure is not limited to the above embodiments, and may be defined by not only the following claims but also equivalents thereof.

A method by which a UE performs communication in a wireless communication system according to an embodiment of the disclosure may include receiving a paging message including slice information from a BS. The method may include performing cell reselection based on the slice information and performing a random access procedure based on a result of the cell reselection.

In an embodiment, the method may include transmitting a message including UE capability information to the BS. The UE capability information may indicate whether cell reselection may be performed based on the slice information.

In an embodiment, the method may include setting frequencies supporting the slice information as highest priority frequencies. The method may include performing the cell reselection based on the highest priority frequencies.

In an embodiment, the method may include setting a slice included in the slice information as a highest priority network slice access stratum group (NSAG). The method may include performing cell reselection based on the highest priority NSAG.

In an embodiment, the method may include, when a cell supporting the slice information is not reselected until a timer expires, performing the random access procedure on a current serving cell.

In an embodiment, the paging message may include a paging record including the slice information, and the slice information may include information related to an NSAG.

A method by which a BS performs cell reselection in a wireless communication system according to an embodiment of the disclosure may include transmitting a paging message including slice information to a UE. The method may include performing a random access procedure based on a result of the cell reselection based on the slice information.

A UE for performing communication in a wireless communication system according to an embedment of the disclosure may include a transceiver and at least one processor connected to the transceiver. The processor may be configured to receive a paging message including slice information from a BS. The processor may be configured to perform cell reselection based on the slice information and perform a random access procedure based on a result of the cell reselection.

A BS for performing communication in a wireless communication system according to an embodiment of the disclosure may include a transceiver and at least one processor connected to the transceiver. The processor may be configured to transmit a paging message including slice information to a UE. The processor may be configured to perform a random access procedure based on a result of cell reselection based on the slice information.

1. A method performed by a user equipment (UE) in a wireless communication system, the method comprising:
receiving a paging message comprising slice information from a base station;
performing cell reselection based on the slice information; and
performing a random access procedure based on a result of the cell reselection.

2. The method of claim 1, further comprising transmitting a message comprising UE capability information to the base station,
wherein the UE capability information indicates whether the cell reselection is performable based on the slice information.

3. The method of claim 1, wherein the performing of the cell reselection comprises:
setting frequencies supporting the slice information as highest priority frequencies; and
performing the cell reselection based on the highest priority frequencies.

4. The method of claim 1, wherein the performing of the cell reselection comprises:
setting a slice included in the slice information as a highest priority network slice access stratum group (NSAG); and
performing the cell reselection based on the highest priority NSAG.

5. The method of claim 1, wherein the performing of the random access procedure further comprises, when a cell supporting the slice information is not reselected until a timer expires, performing the random access procedure on a current serving cell.

6. The method of claim 1, wherein
the paging message comprises a paging record comprising the slice information, and
the slice information comprises information related to an NSAG.

7. A method performed by a base station in a wireless communication system, the method comprising:
transmitting a paging message comprising slice information to a user equipment (UE); and
performing a random access procedure based on a result of cell reselection based on the slice information.

8. The method of claim 7, further comprising receiving a message comprising UE capability information from the UE,
wherein the UE capability information indicates whether the cell reselection is performable based on the slice information.

9. The method of claim 7, wherein the performing of the random access procedure comprises performing the random access procedure on a cell reselected by setting frequencies supporting the slice information as highest priority frequencies.

10. The method of claim 7, wherein the performing of the random access procedure comprises performing the random access procedure on a cell reselected by setting a slice included in the slice information as a highest priority network slice access stratum group (NSAG).

11. The method of claim 7, wherein the performing of the random access procedure further comprises, when a cell supporting the slice information is not reselected until a timer expires, performing the random access procedure on a current serving cell.

12. The method of claim 7, wherein
the paging message comprises a paging record comprising the slice information, and
the slice information comprises information related to an NSAG.

13. A user equipment (UE) for performing communication in a wireless communication system, the UE comprising:
a transceiver; and
at least one processor connected to the transceiver and configured to receive a paging message comprising slice information from a base station,
perform cell reselection based on the slice information, and
perform a random access procedure based on a result of the cell reselection.

14. The UE of claim 13, wherein the at least one processor is further configured to transmit a message comprising UE capability information to the base station,
wherein the UE capability information indicates whether the cell reselection is performable based on the slice information.

15. A base station for performing communication in a wireless communication system, the base station comprising:
a transceiver; and
at least one processor connected to the transceiver and configured to transmit a paging message comprising slice information to a user equipment (UE), and
perform a random access procedure based on a result of cell reselection based on the slice information.
